(19) United States
(12) Patent Application Publication
(10) Pub. No.: US 2025/0384743 A1
(43) Pub. Date: Dec. 18, 2025

(54) CROSS-GAME BONUS BASED ON PLAYER HISTORY AND PREFERENCE

(71) Applicant: IGT, Las Vegas, NV (US)

(72) Inventors: Soheil Latifi, Brampton (CA); Michael Russ, Graz (AT); Gaurav Jariwala, Halifax (CA); Stefan Keilwert, St. Josef (AT)

(21) Appl. No.: 18/746,669

(22) Filed: Jun. 18, 2024

(51) Int. Cl. G07F 17/32; G06N 20/00

(52) U.S. Cl. CPC G07F 17/3267; G06N 20/00; G07F 17/3237; G07F 17/3251

(57) ABSTRACT

The present disclosure relates generally to a gaming system, device, and method supportive of configuring a gaming device to present a preferred bonus game when a bonus game has been triggered during a primary game. An illustrative method includes determining a bonus game preference for a representative player and modifying the bonus game in accordance with deviations of the player from the representative player. A representation of the electronic game is presented on a display device, where the representation of the electronic game includes displaying a plurality of game features, executing the electronic game, determining, during execution of the electronic game, that a bonus game has been triggered and presenting the modified bonus game to the player.

### BACKGROUND

The present disclosure is generally directed toward gaming devices and systems and, more specifically, determining a bonus game preference for a player and an electronic game presenting a bonus game corresponding to the bonus game preference.

In some gaming systems, an Electronic Gaming Machine (EGM) may include functionality that enables the EGM to present a primary game. The EGM determines, during the presentation of the primary game, that a bonus game has been triggered. When the bonus game is triggered, the EGM suspends presentation of the primary game a present the bonus game. After the bonus game ends, the electronic game resumes presentation of the primary game.

### BRIEF SUMMARY

In certain aspects, the present disclosure relates to a gaming system, method, and machine. In particular, aspects of the present disclosure determine if a player of an electronic game has a secondary game preference. When the player is determined to have a secondary game preference, the electronic game presents a preferred secondary game to a player during a secondary game session presented by the electronic game.

Embodiments of the present disclosure aim to determine whether or not a player has a secondary game preference. When a player is determined to have a secondary game preference, the electronic game is configured to execute and present the preferred secondary game. Certain embodiments of the present disclosure configure the electronic game to execute and present the preferred secondary game upon a randomized selection of the preferred secondary game from a plurality of secondary games available. The randomization may further comprise a weighted randomization of the plurality of secondary games wherein the preferred secondary game is more heavily weighted, and therefore statistically more likely to be presented, compared to any other secondary game of the plurality of secondary games. Once a preferred secondary game is selected and presented the weighting of the preferred secondary game may be temporarily decreased.

An illustrative method is provided that includes: presenting, by a processor, a representation of an electronic game on a display device, wherein the representation of the electronic game includes displaying a plurality of game features; executing, by the processor, the electronic game; correlating gameplay of a player in the electronic game to gameplay behavior of one or more players in prior gaming sessions to determine a set of secondary game preferences of the player; determining based on the gameplay of the player that the player is eligible for a secondary game; presenting, during the electronic game, an eligibility indicator for the secondary game; determining, in response to presenting the eligibility indicator for the secondary game, that the player of the electronic game has taken an action that corresponds to a preference to play the secondary game; configuring the secondary game based on the set of secondary game preferences; and executing and presenting, by the processor, the secondary game.

A first illustrative system is provided that includes: a processor; and a memory coupled with and readable by the processor and having stored thereon instructions which, when executed by the processor, cause the processor to: execute an electronic game, wherein the electronic game presents a plurality of game features to a player during execution thereof; correlating gameplay of the player in the electronic game to gameplay behavior of one or more players in prior gaming sessions to determine a set of secondary game preferences of the player; determine, by a machine learning network, that the player has a preference to play a secondary game and in response, enabling play of the secondary game; and determine, during the electronic game, that the player of the electronic game has taken an action that corresponds to the preference to play the secondary game, presenting and executing the secondary game.

A second illustrative system is provided that includes: a processor; and a memory coupled with and readable by the processor and having stored thereon instructions which, when executed by the processor, cause the processor to: generate, by a machine learning model, a representative player of an electronic game comprising a plurality of representative player attributes and a preference for a secondary game of a plurality of secondary games; execute the electronic game, wherein the electronic game presents a plurality of game features to a player during execution thereof; determine a variation of player attributes of the player from the plurality of representative player attributes and modify the secondary game in accordance with the variation; and determine, by the processor, that the electronic game has triggered play of the secondary game and in response executing and presenting, by the processor, the secondary game.

### BRIEF DESCRIPTION OF THE SEVERAL VIEWS OF THE DRAWINGS

FIG. 1 is a block diagram of a gaming system in accordance with aspects of the present disclosure;

FIG. 2A is a block diagram illustrating a first example data structure used in accordance with aspects of the present disclosure;

FIG. 2B is a block diagram illustrating a second example data structure used in accordance with aspects of the present disclosure;

FIG. 2C is a block diagram illustrating a third example data structure used in accordance with aspects of the present disclosure;

FIG. 3 is a block diagram of a gaming device in accordance with aspects of the present disclosure;

FIG. 4 is a block diagram illustrating self-evolving AI-based models in accordance with aspects of the present disclosure.

FIGS. 5A and 5B illustrate a first and second portion, respectively, of a process flow associated with determining of player actions indicating a secondary game preference;

FIG. 6 illustrate a process flow associated with determining an action that indicates a player's secondary game preference;

FIG. 7 illustrates a process flow associated with determining an action that indicates a player's secondary game preference after being presented with a secondary game;

FIG. 8 illustrates a process flow associated with determining of a secondary game in accordance with a representative player and variations therefrom; and

FIG. 9 illustrates a process flow associated with determining of a secondary game in accordance with a representative player generated by a machine learning model.

### DETAILED DESCRIPTION

An electronic game may be presented by an Electronic Gaming Machine (EGM). The electronic game may comprise one or more primary games, commonly displayed as signage, icons, graphics, or other identifiers to enable a prospective player to identify the primary game that will be presented by the electronic game. The prospective player may select a particular primary game from the EGM, when the EGM is configured to present multiple electronic games, or play a different EGM, such as one enabled to present a desired primary game.

EGMs are often enabled to present a bonus game interspersed with presentation of the primary game. The identity of a particular bonus game available may be more difficult or impossible for a prospective player to determine without initiating the primary game and earning a bonus game. As a result, players with a preference for a preferred bonus game may be unable to identify EGMs presenting a primary game that have the potential to present the preferred bonus game.

Systems and methods utilized to determine a player's primary game preference are often unable to determine the player's bonus game preference or whether the player has any such preference. In certain examples, two or more different primary games may be available to the player who then initiates gameplay on a selected one of the primary games. In response, traditional systems and methods will determine that the player has a preference for the selected one of the primary games over the other primary games. However, the player's motivation for selecting the particular primary game may be motivated, partially or entirely, on whether the player will be offered the opportunity to play a preferred bonus game that would not be available if a different primary game were to be played.

Certain players have a greater preference for a particular bonus game versus other bonus games that may be available or even a preference for a bonus game over the primary game. Systems and methods are unable to determine if a player is motivated by a desire for a particular bonus game. As a result, the systems and methods may incorrectly determine that an action taken by the player is an expression of preference for a particular primary game when the player selected primary game based on the availability of a particular bonus game or attempt to locate the particular bonus game. In response, systems and methods may cause actions to be taken that are in error. For example, an erroneous determination that a player prefers a particular primary game may cause the EGM to be modified to present a different primary game with attributes of the particular primary game. As a result, the player may be confused or dissatisfied with the operation of the primary games.

EGMs may be configured to a particular player's preferences. Data processing resources used to determine the player's preference may require additional data that is otherwise unnecessary when the bonus game data is available. Similarly, the amount of data stored and transmitted over a network is reduced if relevant data, such as bonus game preferences, are known and irrelevant or unnecessary data is omitted, such as general data regarding a player that may have no relationship to a bonus game preference. As a result of certain embodiments of the present disclosure, the processing speed of a processor is improved as irrelevant or erroneous data is omitted, and an improved gaming experience is provided to the player.

While some examples in the present disclosure may reference the use of an EGM as a gaming device via which players may participate in gaming activity, it should be appreciated that aspects of the present disclosure are not so limited. For example, any device or collection of devices, such as a computing device, personal gaming device, mobile device, personal gaming device, or collection of computing devices may be used to facilitate invoking or facilitate bonus game preference determination and/or presentation of a preferred bonus game.

Aspects of the present disclosure will be described in connection with improving electronic games and operations thereof to identify players having a preference for a particular bonus game. During gameplay of an electronic game, the electronic game may determine that a bonus or extended game or game feature (collectively “secondary game”) has been triggered and, in accordance with the preference, the particular secondary game is presented. The secondary game may be a distinct extended game or a bonus game that has been configured to present a secondary game with secondary game attributes in accordance with the player's secondary game preferences.

As will be appreciated, a primary or secondary game can be divided into dynamic elements and static elements. In some examples, secondary game attributes include game presentation parameters such as appearance parameters (e.g., graphical theme, font, and color palette), sound effects, sound volume, light effects, haptic effects, and effect patterns, graphics, animations (e.g., symbol animations), animation effects and timing thereof, and other game presentation parameters and game mechanic parameters such as degree of chance, volatility, and/or payout table, game operational parameter (e.g., configuration of game rules, number of reels, weighting of symbols on a reel strip, number of paylines, game speed or urgency (e.g., reel spin duration, speed of wheel or reel-spin, and symbol bounce timing), tenson spins, meter counting algorithms, win conditions, player menu game selection options, re-trigger options, etc.), bonus type (e.g., progressive indicators indicating proximity to award, random or pseudorandom triggered bonus, free game feature (e.g., free spin), monetary award amount, mystery events/wins, etc.), degree of skill, level and/or type of player interaction (e.g., level of perceived persistence or number of perceived persistence effects, player menu options, and other game mechanic parameters and combinations thereof. As will be appreciated, a game theme can be any genre, storyline, or basis of a game or game type. Examples include a movie or TV program such as Lord of the Rings™, Stranger Things™, James Bond™, Willy Wonka™, and Game of Thrones™, a gameshow such as Wheel of Fortune™, Tihe Price is Right™, Pyramid™, Let's Make a Deal™ or Jeopardy™, a historical event or person such as historical events including Romans, Egyptians, Cowboys and the Amazon and historical or living persons including Caesar, Cleopatra, John Wayne, and other genres, storylines, or game bases that are compatible with games and/or attractive to players.

Embodiments of the present disclosure are directed to correlating gameplay of a player of an electronic game to gameplay behavior of the same or a different player in one or more prior gaming sessions to determine a set of secondary game preferences of the player. The set of secondary game preferences can be used to identify players having a preference for secondary game types that drives the players primary game selection. Stated differently, some players are bonus game hunters or chasers that select primary games based primarily on his or her secondary game preferences. As will be appreciated, different primary games are associated with different secondary games. By way of illustration, based on a player's historical gameplay data, AI can be used to provide a best suited or most played theme by the player at the time of the bonus round. A player could set a default unique theme (e.g., lucky theme) for bonuses to create a sense that they can win a large award.

A secondary game can be configured based on the set of secondary game preferences and presented to the player in a gaming session. The configuration parameters altered based on the secondary game preferences of the player can include one or more of the game presentation and game mechanic parameters referenced above. The secondary game can include one or more different appearance or game mechanic parameters compared to a default secondary game associated with the primary game.

Differences between the preferred secondary game and the default secondary game may alternately be categorized as gameplay affecting and/or non-gameplay affecting. Gameplay affecting differences affect one or more of the operation of the electronic game, primary game, preferred bonus game, or a third game that may be presented by electronic game or a second electronic game. Gameplay affecting differences include the game itself being different (e.g., a blackjack bonus game versus a Texas Holdem' bonus game), a type of bonus game being different (e.g., a card game versus a dice bonus game), or the prospective benefit of the preferred bonus game (e.g., a casino perk versus a free spin). Additionally or alternatively, non-gameplay affecting differences between the preferred bonus game from the default bonus game include visual, audio, and haptic outputs variations of the primary game, preferred bonus game, and/or a third game presented by the electronic game and/or the second electronic game.

Embodiments of the present disclosure include determining the secondary game preferences of a player or group of players. In some aspects, the secondary game preference is determined by explicit inputs received when a player is presented with the choice of two or more secondary games. In other aspects, the secondary game preference is determined by observing changes in the player's behavior when presented with a secondary game prompt identifying a future secondary game and/or after a secondary game has been presented. Additionally or alternatively, changes in a pattern of gameplay with a primary game after being presented with a secondary game are observed and processed to determine if the player enjoyed playing the secondary game, and therefore has a preference for the secondary game presented, or was neutral or disfavored playing the secondary game, and therefor has a preference for other secondary games and/or a negative preference for the presented secondary game. The player's preference may be determined for secondary games in general or for specific secondary games and/or categories of secondary games.

A player's gameplay may alter when presented with a secondary game prompt during gameplay of the primary game, such as a change in gameplay observed after a prompt announcing a secondary game may become available. The prompt may identify an opportunity to play an unidentified secondary game. In response, the EGM may receive player inputs in a pattern that is determined to vary from their previous pattern before the prompt was presented. For example, a player may be prompted with a notification that a secondary game may become available, whether or not the specific criteria for triggering the secondary game are identified. If the EGM receives a pattern of gameplay that is consistent with a previous pattern of gameplay, such as speed of gameplay and wager amount, the player may be determined to be unaffected by the opportunity to play a secondary game and, therefore, not have a secondary game preference for any secondary game. However, if the EGM receives a change in the pattern of the player's actions, such as a change in gameplay speed or wager amount, then the player is likely interested in secondary games in general. Additionally or alternatively, the EGM may present a prompt for one or more specific secondary games or attributes of the secondary game. Accordingly, if the EGM receives a change in the player's actions, the player may be determined to have a secondary game preference for one or more of the specific secondary games. A more refined determination may be provided by determining the player's reaction to an explicit choice for one of a plurality of secondary games or a degree of change in response when serially presented with prompts for different secondary games. In yet another embodiment, secondary game preference may be determined explicitly, such as with a questionnaire asking the player to identify their preference for a specific secondary games and/or secondary game attributes.

In some embodiments, one or more self-evolving, AI-based model(s) observes all players' gameplay behaviors to determine each player's set of secondary game preferences and select a secondary game from a pool of secondary games based on the set of secondary game preferences. For example, if a player has played at least X different bonuses and focusses on progressive bonuses, primary games played by the player will be modified to offer only progressive bonuses even though the primary game's default secondary game is a different type of bonus.

In some embodiments, player historical data annotated with the version of the game played is extracted in a time series dataset format. The self-evolving, AI-based model(s) is trained with the time series dataset in a timely manner. While any self-evolving, AI-based model can be employed, the model is typically a large language model or any recurrent neural network that is suited for time series data. The output is a set of secondary games that have at least a threshold probability of being preferred by the player with a corresponding probability for each secondary game in the set. A particular secondary game can be selected based on any suitable algorithm, such as by random or pseudorandom number selection, and stitched into the primary game to be played or currently being played by the player in lieu of a default secondary game for the primary game.

The secondary games are typically assigned a corresponding identifier and are defined by corresponding game template comprising a default set of game parameters, which may be game appearance or game mechanics parameters or gameplay affecting and/or non-gameplay affecting parameters or other parameters depending on the application. The templates may comprise a full or only a partially populated set of predetermined game parameters. For example, the secondary game template can be stored un-themed (or in an original theme) and executed in a primary game of a completely differently themed game, with the secondary game's theme being adapted to align with the primary game theme. Alternatively, the secondary game template is stored in an originally assigned theme and the primary game is changed to the secondary game's theme. Stated differently, the player plays a primary game having theme A and triggers a secondary game template, such as a bonus, of a different primary game having theme B (which is the one preferred by the player) and the player is provided with the bonus having theme B. Additionally, or alternatively, the secondary game may apply a modification to the primary game. For example, a secondary game's theme or other audio-visual features may be selectively applied to some or all of the primary game. The gameplay of the primary game may be modified in accordance with the secondary game. Examples of modifications to the gameplay of the primary game may include adding a game component (e.g., puzzle piece, quest objective), remove a negative gameplay element (e.g., “lose a turn”), add a positive gameplay element (e.g., “free spin”), and/or modify a payout. The modification(s) to the primary game may have a limited lifespan, such as to be limited to a set number of gameplays or time. The lifespan of the modification may be further modified such as by subsequent gameplay of the primary and/or secondary game. For example, successfully completing the secondary game may result in one free spin in the primary game and a subsequent successful completion of the secondary game, such as within the same gaming session, results in three free spins in the primary game.

The secondary game template library can comprise combinable templates for unit secondary game operations that can be mixed and matched to form an aggregated template for a secondary game. The various components can be selected based on a player's set of secondary game preferences. By way of illustration, a bonus can have multiple components that a player can trigger in a base or primary game, including components the player likes or match the player's secondary game preferences. Such components can be combined in a secondary game template to appear more frequently or exclusively when compared to other secondary games. For example, such components can include the bonus' number of reels, number of paylines, theme, win conditions, re-trigger options, and the like. Within the primary game, variants of these components can be triggered, and when entering the secondary game, the triggered variants of the components can be combined to form an aggregated secondary game template. In other words, the player can build the secondary game template as he or she is playing a primary game and within the primary game the player can develop an idea of what the secondary game components will be.

By way of further illustration, the secondary game template can be defined to include multiple game components defined as payout-relevant (e.g., type of bonus, volatility, etc.) and non-payout-relevant (e.g., timing, sounds, animation, etc.) game configuration options that are mixed and matched to create an optimal match for a selected player based upon historical player preferences and AI-driven recommendations. To illustrate, the secondary game template would include combinable payout relevant configuration options of operations of “best” configurable win-amount of bonus win for a selected player, mystery events/wins, etc. and non-payout-relevant configuration options of theme, graphical symbol selections, animations, timing of animations, number of selections, sound type and frequency, etc.

The AI models described herein can further be employed to configure the primary game using the above techniques disclosed for secondary game configuration. By way of illustration, the AI-configured primary game can include both payout-relevant and non-payout relevant configuration options. The non-payout-relevant configuration options include without limitation reel-spin duration, speed of reel spin, symbol-bounce timing, meter counting algorithms, sound/light/haptic effects and effect patterns, graphics and animations (e.g., symbol animations), graphical theme, fonts, animation effects, tension spins and perceived persistence effects and the like while payout-relevant configuration options include without limitation configuration of game rules, win amounts, weighting of symbols on reel strip, size of bonus wins, and the like.

A “bonus hunter” achievement system may be employed that tracks how many and which secondary games the player has played, categorizes bonus types (e.g., pick features, FG features, digit build features, etc.), and categorizes bonus themes (e.g., fruit bonuses, Egypt bonuses, jungle bonuses, etc.). The achievement system can show the player's achievement progress only of his or her preferred secondary game categories (e.g., “you have unveiled 13 out of 16 pick features”). A nonfungible token or NFT can be provided to players for achieving certain milestones of bonuses.

Either after triggering a generic bonus, the player can be given the choice which one he or she wants to play or he or she will be given the choice which bonus shall be the next one they can trigger. The player may be given a choice of two options where a first option may be a bonus he or she has played and liked and the second option may be a game he or she has not played yet but one that is proposed to the player.

The various model(s) can induce an illusion of gaming system familiarity and awareness of the player's needs, desires, and activities, which can enhance player trust in the gaming system and player satisfaction, increase player engagement, and enable gaming systems operators to have higher levels of floor (e.g., casino gaming device) utilization by customizing secondary games to the particular preferences of selected players. The gaming system can further increase player engagement and trust of the gaming system by allowing a player to engage with a gaming device providing content customized to the player's preferences. By way of illustration, the player feels that he/she is communicating directly with a customized and personalized gaming system component even though the gaming device is actually receiving content from a server.

In some gaming environments (e.g., casino environments), an EGM may include a player behavior model (e.g., a gameplay assistant, a gameplay model, a player companion, etc.) which, when activated during a gameplay session at the EGM, may assist the player and/or server as a personalization enabler. However, in some other implementations of player behavior models, the player behaviors are hard-coded and created with either common player traits (e.g., generic behaviors, personalities, etc.) and/or are based upon a relatively limited number of parameters. A technical problem of such player behavior models is their inability to behave “intelligently” (e.g., in more complex gameplay situations) in supporting user-tailored experiences. For example, in some systems, such player behavior models are not fed with additional data (e.g., feedback, gameplay data, etc.) and are unable to evolve beyond a base model. In some cases, the player behavior models are incapable of drawing on self-learning implications.

A further technical problem of existing player behavior models is how to create, update, maintain and use output from numerous player-specific self-evolving AI-based behavior models to enhance performance of a gaming system. Data processing to maintain these models, in real-time across many players at one-second intervals, is computationally challenging and intensive. How to incorporate such models into existing gaming systems to enhance gaming system operation and player enjoyment without undue computational costs and processing latency creates yet another technical problem.

A technical solution provided by aspects of the present disclosure combines player-specific behavior models with representative player behavior, secondary game configuration, and demographic predictive models in a casino environment (e.g., associated with EGMs) in which the models are capable of self-evolving (also referred to herein as self-learning) based on gameplay decisions, gameplay outcomes, and other player related parameters (e.g., behavioral shifts in gameplay decisions, biometric data, wager behavior, etc.). Player behavior can include, for example, gameplay patterns and/or gameplay style of a player. For example, a gameplay system may support initial training and creation of a baseline model, in which the baseline model is associated to a corresponding object (e.g., individual player, representative player, gaming system, or reward program). The system may continuously feed the model with real time player and gaming system data (e.g., gameplay decisions, behavioral shifts, button inputs, etc.) generated by the player or EGM or other gaming system component in association with a gameplay session. In some aspects, via AI mechanisms, the model may self-evolve to enhance itself in order to optimize the gaming experience for the player. In addition to the models to use real-time gameplay data to maintain/update/improve model capabilities, the models can provide output to the operator that can be used internally (for in-depth analysis purposes). Aspects of the present disclosure describe example techniques associated with generating such models, example methods of implementing the models in a gameplay environment (e.g., casino environment), examples of modifying the models, and example use-cases thereof.

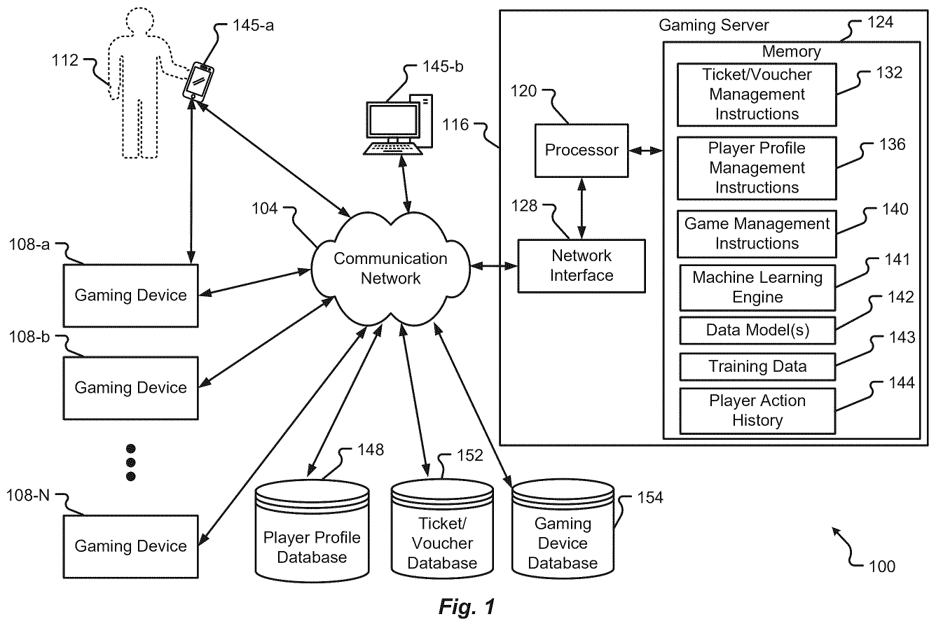

With reference initially to FIG. 1, details of an illustrative gaming system 100 will be described in accordance with at least some embodiments of the present disclosure. The components of the gaming system 100, while depicted as having particular instruction sets and devices, are not necessarily limited to the examples depicted herein. Rather, a system according to embodiments of the present disclosure may include one, some, or all of the components depicted in the gaming system 100 and does not necessarily have to include all of the components in a single device. For example, the components of a server may be distributed amongst a plurality of servers and/or other devices (e.g., a gaming device, a portable/mobile user device, etc.) in the gaming system 100 without departing from the scope of the present disclosure.

The gaming system 100 may include a communication network 104 that interconnects and facilitates machine-to-machine communications between one or multiple gaming devices 108 (e.g., any of gaming device 108-a through 108-N) and a gaming server 116. It should be appreciated that the communication network 104 may correspond to one or many communication networks without departing from the scope of the present disclosure. In some embodiments, gaming device 108-a through gaming device 108-N and gaming server(s) 116 may be configured to communicate using various nodes or components of the communication network 104. The communication network 104 may include any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may include a number of different communication media such as coaxial cable, copper cable/wire, fiber-optic cable, antennas for transmitting/receiving wireless messages, and combinations thereof.

In some embodiments, the gaming devices 108 (e.g., gaming device 108-a through gaming device 108-N) may be distributed throughout a single property or premises (e.g., a single casino floor), or the gaming devices 108 (e.g., gaming device 108-a through gaming device 108-N) may be distributed among a plurality of different properties. In a situation where the gaming devices 108 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming devices 108 (e.g., gaming device 108-a through gaming device 108-N) may utilize the same or different types of communication protocols to connect with the communication network 104. It should also be appreciated that the gaming devices 108 (e.g., gaming device 108-a through gaming device 108-N) may present the same type of game or different types of games to a player 112. For example, the gaming device 108-a may correspond to a gaming machine that presents a slot game to the player 112, the gaming device 108-b may correspond to a video poker machine, and other gaming devices 108 may present other types of games (e.g., keno, sports wagering, etc.) or a plurality of different games for selection and eventual play by the player 112.

In some aspects, some of the gaming devices 108 (e.g., gaming device 108-a through gaming device 108-N) may communicate or exchange data with one another via the communication network 104. In some embodiments, one or more of the gaming devices 108 may be configured to communicate directly with a centralized management server and/or the gaming server 116. Although not depicted, the gaming system 100 may include a separate server or collection of servers that are responsible for managing the operation of the various gaming devices 108 in the gaming system 100.

It should also be appreciated that the gaming server 116 may or may not be co-located with one or more gaming devices in the same property or premises. Thus, one or more gaming devices 108 may communicate with the gaming server 116 over a WAN, such as the Internet. In such an event, a tunneling protocol or Virtual Private Network (VPN) may be established over a portion of the communication network 104 to ensure that communications between a gaming device 108 and the server 116 (e.g., a remotely-located server) are secured.

The gaming devices 108 (e.g., gaming device 108-a through gaming device 108-N) may correspond to a type of device that supports interaction by a player 112 in connection with playing games of chance. Examples of a gaming device 108 may include any type of known gaming device such as an EGM, a slot machine, a table game, an electronic table game (e.g., video poker), a skill-based game, etc. In addition to playing games on a gaming device 108, the player 112 may also be allowed to interact with and play games of chance on a communication device 145a or communication device 145b.

The gaming system 100 may support interaction with one or more communication devices 145. A communication device 145 (e.g., communication device 145-a) may be a mobile device of a player 112 (e.g., a personal communication device such as a smart phone, a tablet, a smart watch, etc.) or to a device issued by a casino to the player 112. It should be appreciated that the player 112 may play games directly on the communication device 145. Alternatively, or additionally, the communication device 145 may establish a communication link (e.g., over a wireless or wired connection) with a gaming device 108 such that the communication device 145 provides an interface for the player 112 to interact with the gaming device 108. As shown in FIG. 1, the communication device 145 may be in communication with the communication network 104 or in direct communication (e.g., via Bluetooth, WiFi, etc.) with a gaming device 108. Non-limiting examples of a communication device 145 include a cellular phone, a smart phone, a tablet, a wearable device, an augmented reality headset, a virtual reality headset, a laptop, a Personal Computer (PC), or the like. In some cases, another communication device 145 (e.g., communication device 145-b) may be a mobile device, a PC, or the like of a casino operator (e.g., a floor attendant, a casino manager, etc.).

In some cases, the gaming system 100 may support “carding in” of a player at a gaming device 108 with a physical card (e.g., a player club card). In other cases, the gaming system 100 may support “carding in” of a player at a gaming device 108 via a mobile application on a communication device 145. In some aspects, the mobile application may support fund transfers between a player account and the gaming device 108 (e.g., a server, the casino). For example, using the mobile application, the player may transfer funds to a gaming session.

In an example of “carding in,” the communication device 145 may exchange information with the gaming device 108 over a wireless connection (e.g., near field communication (NFC), Bluetooth, etc.) when the communication device 145 is within a threshold distance of the gaming device 108. In another aspect, the communication device 145 may “card in” and exchange information with the gaming device 108 when the communication device 145 is connected to the gaming device 108 using a physical communications link (e.g., a communications cable). In an example, when “carding in,” the communication device 145 may provide player identification information (e.g., player identity, player club status, player preference information, etc.) to the gaming device, the server, and/or the gaming system. The gaming server 116 (or the gaming device 108) may establish a gaming session at the gaming device 108 for the player based on the information provided during the “card in”.

The gaming server 116 is further shown to include a processor 120, a memory 124, and a network interface 128. These resources may enable functionality of the gaming server 116 as will be described herein. For example, the network interface 128 provides the server 116 with the ability to send and receive communication packets or the like over the communication network 104. The network interface 128 may be provided as a network interface card (NIC), a network port, drivers for the same, and the like. Communications between the components of the server 116 and other devices connected to the communication network 104 may all flow through the network interface 128.

The processor 120 may correspond to one or many computer processing devices. For example, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), a Graphics Processing Unit (GPU), or plurality of microprocessors that are configured to execute the instructions sets stored in memory 124. Upon executing the instruction sets stored in memory 124, the processor 120 enables various authentication functions of the gaming server 116.

The memory 124 may include any type of computer memory device or collection of computer memory devices. The memory 124 may be volatile or non-volatile in nature and, in some embodiments, may include a plurality of different memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. Although not depicted, the memory 124 may include instructions that enable the processor 120 to store data to and retrieve data from a player profile database 148, a ticket/voucher database 152, and/or a gaming device database 154.

Alternatively or additionally, the player profile database 148 or data stored thereon may be stored internal to the any of the communication device 145, a gaming device 108, and/or the server 116 (e.g., within the memory 124 of the server 116 rather than in a separate database). Alternatively or additionally, the ticket/voucher database 152 or data stored therein may be stored internal to the server 116. Alternatively or additionally, the gaming device database 154 or data stored thereon may be stored internal to the server 116.

The databases described herein (e.g., player profile database 148, ticket/voucher database 152, gaming device database 154) may include a relational database, a centralized database, a distributed database, an operational database, a hierarchical database, a network database, an object-oriented database, a graph database, a NoSQL (non-relational) database, etc. In some aspects, the databases may store and provide access to, for example, any of the stored data described herein.

The illustrative instruction sets that may be stored in memory 124 include, without limitation, a ticket/voucher management instruction set 132, a player profile management instruction set 136, and a game management instruction set 140. Functions of the server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 116. Said another way, the instruction sets depicted in FIG. 1 should not be construed as limiting embodiments described herein.

In some embodiments, the ticket/voucher management instruction set 132, when executed by the processor 120, may enable the gaming server 116 to manage various tickets/vouchers issued by gaming devices 108 (e.g., gaming device 108-a through gaming device 108-N), manage ticket/voucher values, determine ticket/voucher states, update the ticket/voucher database 152, obtain information from the ticket/voucher database 152, determine that a ticket/voucher has been redeemed and notify the player profile management instruction set 136, etc. In embodiments where the ticket/voucher instruction set 132 is implemented in one system (e.g., a ticketing/voucher system) and the player profile management instruction set 136 is implemented in a separate system (e.g., a player tracking system), a communication link may or may not be implemented between the two systems. In such a situation, the tickets/vouchers issued by the ticketing/voucher system may be anonymous and not necessarily associated with any particular player or player profile.

In some embodiments, the ticket/voucher management instruction set 132 may be configured to perform any action consistent with the issuance of tickets/vouchers, tracking of ticket/voucher states, and determining whether/when/where a ticket/voucher has been redeemed. In some embodiments, the ticket/voucher management instruction set 132 may be configured to generate, or cause the game management instruction set 140 to generate, a synthesized credit meter for the first gaming device. For example, as gaming devices 108 (e.g., gaming device 108-a through gaming device 108-N) or a communication device 145 have their credit meters updated, the gaming server 116 may update a corresponding synthesized credit meter to reflect updates at the credit meters. In some embodiments, values of credit or other events stored in credit meters of gaming device 108 and/or a communication device 145 may be mirrored in a synthesized credit meter maintained by the gaming server 116.

The player profile management instruction set 136, when executed by the processor 120, may enable the gaming server 116 to manage one or more player profiles within the player profile database 148. In some embodiments, the player profile management instruction set 136 may be configured to manage a player loyalty profile including settings for such player profiles, available wager credits for such profiles, determine player wager history, retrieve a player action history 144 associated with a player 112, and/or determine which, if any, tickets/vouchers are associated with a particular player 112. It should also be appreciated that the player profile management instruction set 136 may be configured to manage player profiles of players that do not have loyalty accounts or any other predetermined player account. As will be described in further detail herein, the player profile management instructions 136 may cooperate with instructions on a gaming device 108 to facilitate or enable the determination of a bonus game preference and/or modifying gaming device 108 to present a bonus game in accordance with the bonus game preference.

In some aspects, the player profile management instruction set 136 may be configured to manage a player action history 144 associated with gameplay sessions. In an example, the player action history 144 may include user behavior (e.g., gameplay decisions) associated with previous and/or current gameplay sessions. In some other examples, the player action history 144 may include descriptions of actions (e.g., in-game and non-game actions) that are taken by a particular player 112 and the context surrounding such actions. The player action history 144 may, in some embodiments, be used to determine or define a normal gaming behavior for a player 112 (e.g., a baseline behavior) such that deviations from the normal gaming behavior for the player 112, when presented with a bonus game prompt, can potentially be identified as an exhibiting a bonus game preference. Conversely, a player's 112 current gameplay behavior does not deviate, or deviates below a previously determined threshold, in response to a bonus game prompt can be potentially identified as having no bonus game preference or, in some embodiments, no bonus game preference for a particular bonus game presented by the prompt.

The game management instruction set 140, when executed by the processor 120, may enable the gaming server 116 to manage the various games played by a player 112 at the gaming devices 108 (e.g., gaming device 108-a through gaming device 108-N) and/or a communication device 145 carried by the player 112. For example, any game played by the player 112 at any of the gaming devices 108 and/or communication device 145 may be managed, partially or entirely, by execution of the game management instruction set 140. The game management instruction set 140 may also be configured to track a status of wager events (e.g., non-EGM wager games, sporting events, bingo, keno, lottery, etc.) and whether a player 112 has placed a wager on such events. In some embodiments, when a wager event has come to completion such that wagers made on the event become payable (e.g., at the end of a gameplay decision at a gaming device 108 and/or communication device 145, at the end of a sporting event when the final score of the event is determined), the game management instruction set 140 may notify the ticket/voucher management instruction set 132, thereby enabling the ticket/voucher management instruction set 132 to update states and/or values of tickets/vouchers issued for the event appropriately.

In some aspects, the game management instruction set 140, when executed by the processor 120, may enable the gaming server 116 to manage and/or monitor data associated with a gameplay session at a gaming device 108. For example, the gaming server 116 may support example aspects described herein of monitoring user information (e.g., member identification information, player club status, etc.), gameplay data (e.g., quantity of plays, quantity of spins, duration of gameplay, credits spent, credits earned, etc.), and actions (e.g., in-game and non-game actions) associated with a gameplay session at the gaming device 108.

In an example, the gaming server 116 may support example aspects described herein of identifying historical data (e.g., previous gameplay decisions) associated with previous gameplay sessions at gaming devices 108. In another example, the gaming server 116 may support example aspects described herein of identifying current data (e.g., gameplay decisions) associated with a current gameplay session at a gaming device 108. The gaming server 116 may provide any of the historical data and/or current data to a machine learning engine 141 (e.g., as inputs to a data model(s) 142, as training data 143, etc.), example aspects of which are described herein. In some aspects, gameplay decisions may be associated with decision events such as wager selections, gameplay choices (e.g., a player decision in a video poker game, selected pay lines at a slot machine, etc.), bonus/prize selections, etc.

In some examples, the game management instruction set 140 may cooperate with the player profile management instruction set 136 to identify and present secondary game prompts, such as a graphic presenting a growing bag of gold, whether or not any actual value is associated with the graphic, and actions corresponding to a preference for the secondary game. The game management instruction set 140 and player profile management instruction set 136 may also cooperate to correlate the secondary game preference to one or more secondary games or corresponding configurations of the secondary game. The game management instruction set 140 and player profile management instruction set 136 may also cooperate to correlate secondary games preferences to one or more rewards for the player 112. Such rewards may include in-game reward and/or non-game rewards.

According to example aspects of the present disclosure, the processor 120 may utilize data stored in the memory 124 as a neural network. The neural network may be, for example, a machine learning network and may include a machine learning architecture. In some aspects, the neural network may be or include an artificial neural network (ANN). In some other aspects, the neural network may be or include any machine learning network such as, for example, a deep learning network, a convolutional neural network, or the like. Some or all of instructions or instruction sets stored in the memory 124 and some functions of the gaming server 116, gaming devices 108, and/or communication devices 145 may be implemented using machine learning techniques. In some cases, the machine learning techniques may include deep learning and reinforcement learning.

In some embodiments, the data model(s) 142 may include one or more secondary game preference models that are specifically trained to support an identification of secondary game preferences, secondary game dislikes, and/or secondary game indifference behaviors. As a non-limiting example, a data model 142 implemented as a secondary game preference gaming model may include a recurrent neural network. In some embodiments, the training data 143 used to train such a data model 142 may include the Nth latest actions and outcomes of the player(s) 112 with which the data model 142 is associated. The data model 142, in some embodiments, may be determined ready for use within the gaming server 116 when an optimal number of actions are determined that is not too wide (high accuracy, but means it takes more actions to detect behaviors) or too short (low accuracy but fast response from the model).

The recurrent neural network may be trained on randomly selected sequences from one or many gaming sessions. In some embodiments, these sequences can be rated by experts, the rating showing the degree of risk associated with the session. The training window is changed during each training session so that it can be determined how many transactions are needed for assessing risky behavior. After training, the data model 142 implemented as the secondary game preference model can rank future gaming sessions based on a preference or dislike and/or a degree of preference or dislike. As for the model architecture, either long short-term memory models or transformers based on their performance can be used.

In some aspects, the neural network may support K-means clustering of training data 143. For example, the training data 143 may include gameplay data and player behavior (e.g., player decisions) associated with previous gameplay sessions at gaming devices 108 (e.g., based on game type, based on a player profile, etc.). In some examples, the training data 143 may include gameplay data and player behavior (e.g., player decisions) associated with a current gameplay session at a gaming device 108. For example, the training data 143 may include previous data (e.g., gameplay data, player behavior, gameplay decisions, etc.) from the same player as well as previous data (e.g., gameplay data, player behavior, gameplay decisions, etc.) from other players (e.g., similar players, players having similar playstyle characteristics, etc.) in the venue.

In an example, the training data 143 may include a dataset (e.g., gameplay data, player behavior, etc.), and the neural network may implement a K-means algorithm which includes iteratively partitioning the dataset into K pre-defined, distinct, non-overlapping subgroups (also referred to herein as clusters or playstyles) where each data point belongs to only one subgroup. In some cases, implementation of the K-means algorithm may include partitioning the dataset such that intra-cluster data points are as similar as possible (e.g., within a threshold criteria) while clusters are as different (e.g., far, in accordance with a threshold distance) as possible.

In an example, the clusters may be identifiable from the analyzed dataset (e.g., gameplay data) based on a set of features pre-defined at the gaming system 100. In some aspects, the gaming system 100 may support defining and/or modifying (e.g., redefining, reconfiguring) the set of features at the gaming server 116 or a communication device 145 (e.g., by a casino establishment, a casino manager, etc.).

Example features include: a credit amount at the start of a gameplay session (e.g., ‘SumCashInAmount’), a credit amount at the end of a gameplay session (e.g., ‘SumCashOutAmount’), quantity of wager adjustments during a temporal period and/or during a gameplay session (e.g., ‘No. of bet changes’), a ratio of a wager amount to a player bankroll (e.g., ‘Wager-Bank-Ratio’), gameplay duration associated with gameplay session (e.g., ‘TimePlayed’), average wager amount for a primary game (base game) (e.g., ‘AverageWagerPrimary’), an average win amount associated with a primary game (e.g., ‘AveragePrimaryWinAmount’), quantity of primary games played during a temporal period and/or during a gameplay session (e.g., ‘No.PrimaryGamesPlayed’), quantity of secondary games (bonus games) played during a temporal period and/or during a gameplay session (e.g., ‘No.SecondaryGamesPlayed), or the like.

The memory 124 may be configured to store program instructions (instruction sets) that are executable by the processor 120 and provide functionality of a machine learning engine 141. The memory 124 may also be configured to store data or information that is useable or capable of being called by the instructions stored in memory 124. One example of data that may be stored in memory 124 for use by components thereof is a data model(s) 142 and/or training data 143. The data model(s) 142 may be a neural network model. The training data 143 may include training data and feedback.

The machine learning engine 141 may include a single or multiple engines. The gaming server 116 (e.g., the machine learning engine 141) may utilize one or more data models 142 for recognizing and processing information obtained from gaming devices 108, communication devices 145, other servers, and/or databases (e.g., player profile database 148, gaming device database 154, ticket/voucher database 152). In some aspects, the gaming server 116 (e.g., the machine learning engine 141) may update one or more data models 142 based on learned information included in the training data 143. In some aspects, the machine learning engine 141 and the data models 142 may support forward learning based on the training data 143. The machine learning engine 141 may have access to and use one or more data models 142. For example, the data model(s) 142 may be built and updated by the machine learning engine 141 based on the training data 143. The data model(s) 142 may be provided in any number of formats or forms. Non-limiting examples of the data model(s) 142 include autoregressive models, Decision Trees, Random Forest, Support Vector Machines (SVMs), Nearest Neighbor, and/or Bayesian classifiers.

The training data 143 may include any data managed by the gaming server 116 with respect to the ticket/voucher management instruction set 132, the player profile management instruction set 136, and/or the game management instruction set 140 described herein. For example, the training data 143 may include player histories (e.g., gameplay data, player behavior, etc.) associated with gameplay sessions at a gaming device(s) 108. In some aspects, the training data 143 may be stored (e.g., in the memory 124, a database, etc.) according to player profile and/or game type. In some examples, the training data 143 may include player histories (e.g., player action history 144). In some aspects, the machine learning engine 141 may be configured to analyze aggregated player histories, gameplay data, in-game actions, and non-game actions, that are historical or in real-time.

The machine learning engine 141 may build any number of configuration profiles (e.g., player profiles, gaming device 108 profiles, playstyle profiles) using automatic processing, using artificial intelligence and/or using input from one or more users associated with the communication device 145. The machine learning engine 141 may use automatic processing, artificial intelligence, and/or inputs from one or more users of the communication devices 145 to determine, manage, and/or combine information relevant to a configuration profile. Example aspects of such configuration profiles are described in further detail below.

The machine learning engine 141 may determine configuration profile information based on a user's interactions with information. The machine learning engine 141 may update (e.g., continuously, periodically, etc.) configuration profiles based on new information that is relevant. The machine learning engine 141 may receive new information from any communication device 145, the gaming server 116, any database described herein, etc. Profile information may be organized and classified in various manners. In some aspects, the organization and classification of configuration profile information may be determined by automatic processing, by artificial intelligence and/or by one or more users of a communication device 145 (e.g., a player, casino personnel, a casino manager, etc.).

In an example, the gaming server 116, a gaming device 108 and/or a communication device 145 may provide, to the machine learning engine 141, gameplay data and/or user information associated with a gameplay session (e.g., previous or current) at the gaming device 108. In an example, the gameplay data may include a quantity of plays (e.g., number of spins), duration of gameplay, credits spent, credits earned, etc. In some examples, the user information may include player identification information (e.g., stored on a player identification card, associated with a player access code, stored on a communication device 145 of a player, etc.).

Data within the database of the memory 124 may be updated, revised, edited, or deleted by the machine learning engine 141. In some aspects, the machine learning engine 141 may support continuous, periodic, and/or batch fetching of data (e.g., from gaming devices 108, communication devices 145, databases, servers, etc.) and data aggregation.

In some aspects, the player profile management instruction set 136 may be configured to manage a player history associated with gameplay sessions. In an example, the player history may include user behavior (e.g., gameplay decisions) associated with previous and/or current gameplay sessions.

For example, the player history may include instances of bonus games, jackpots, secondary bonus games, or other gameplay rewards previously earned by the player and associated gameplay behavior (e.g., gameplay parameters indicating a player's increase of engagement resulting from receiving the bonus game, jackpot, secondary bonus game, or other gameplay reward). As will be appreciated, the instances can be vector representations (e.g., attributes or features) of monitored or tracked player behavior. The player history may include gameplay decisions (e.g., predicted secondary game configurations based on a player behavior, actual user decisions corresponding to predicted secondary game configurations, etc.) associated with a secondary game.

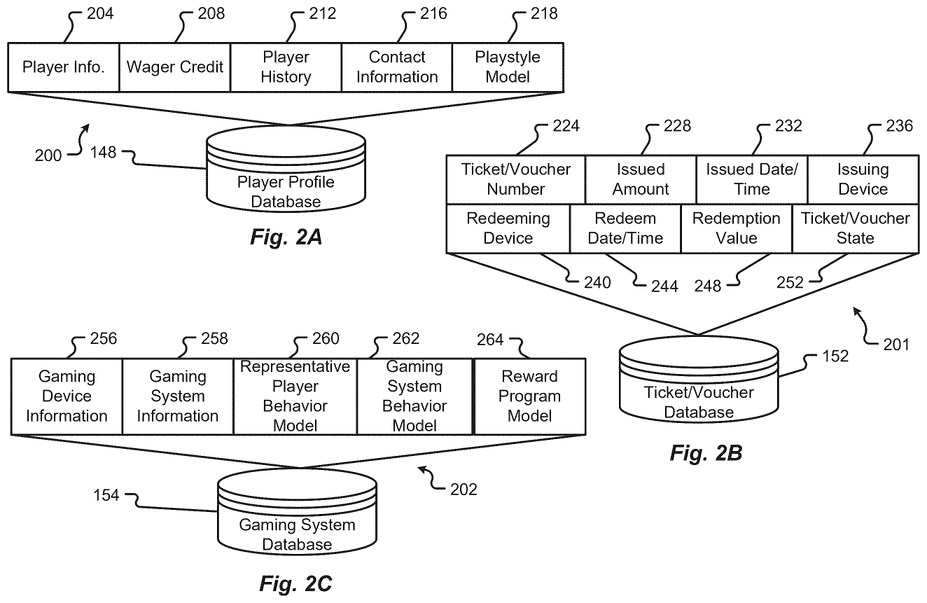

With reference now to FIGS. 2A through 2C, additional details of data structures that are useable in connection with managing auto play modes and playstyle models at a gaming device will be described in accordance with at least some embodiments of the present disclosure. It should be appreciated that the data structures depicted and described herein may be stored within a central database or may be distributed among a number of data storage nodes. Alternatively or additionally, some or all of the fields of the data structures may be maintained in devices of the gaming system 100 such as the gaming server 116, a gaming device 108, and/or a communication device 145 without departing from the scope of the present disclosure.

With reference initially to FIG. 2A, details of a data structure 200 that may be maintained as part of a player profile will be described in accordance with at least some embodiments of the present disclosure. The database 148 may be configured to store one or multiple data structures 200 that are used in connection with tracking player progress and gaming history. In some embodiments, the data stored in the data structure 200 may be stored for a plurality of different player profiles or for a single player profile. As a non-limiting example, the data structure 200 may be used to store player loyalty information, player history information, and the like. Even more specifically, the data structure 200 may include a plurality of data fields that include, for instance, a player information field 204, a wager credit field 208, a player history field 212, a contact information field 216, and a playstyle model field 218.

The player information field 204 may be used to store any type of information that identifies a player or a group of players. In some embodiments, the player information field 204 may store one or more of username information for a player 112, password information for a player account, player status information, accommodations associated with the player 112, and any other type of customer service management data that may be stored with respect to a player 112.

The wager credit field 208 may be used to store data about the available credit of a player 112 with a device, with a sports book, with a casino, and/or with a plurality of casinos. For instance, the wager credit field 208 may store an electronic record of available credit in the player's account and whether any restrictions are associated with such credit. The wager credit field 208 may further store information describing a player's available credit over time, cash out events for the player, winning events for the player 112, wagers placed by the player 112, tickets/vouchers issued to the player 112, and the like.

The player history field 212 may be used to store historical data for events that occur with respect to the player 112. For example, the player history field 212 may store information associated with the player 112 in relation to an outcome in a game of chance, an outcome in a game of skill, a celebration event for a person other than the player 112, involvement in a celebration event, visits to a predetermined location, gameplay information with respect to a particular game, player interactions with a communication device 145, player interactions (e.g., gameplay decisions) with a gaming device 108, wagers placed by the player 112, tickets/vouchers issued for the player 112, tickets/vouchers redeemed by the player 112, etc.

In some other examples, the player history field 212 may store user actions taken by a user. Illustratively and without limitation, the player history field 212 may store information describing in-game actions and non-game actions that are taken by the player 112. The player history field 212 may include data describing a baseline gaming behavior that is unique to the player 112 and/or secondary game preference behavior that is unique to the player 112.

The contact information field 216 may store information associated with a preferred mode(s) of contact for the player 112 and how such contact can be made. For instance, the contact information field 216 may store information such as an email address, phone number, room number, player loyalty number, address, etc.

The playstyle model field 218 may store user decisions by the player 112 in relation to instances of a player 112 responding to the opportunity to play any secondary game or a particular secondary game. The playstyle model field 218 may also store information describing when/if a player 112 declines a secondary game opportunity or exhibits indifference to a secondary game opportunity.

With reference now to FIG. 2B, details of another data structure 201 that may be used within the gaming system 100 will be described in accordance with at least some embodiments of the present disclosure. The database 152 may be configured to store one or multiple data structures 201 that are used in connection with tracking ticket/voucher status, value, and the like. In some cases, the data structures 201 may be used in connection with tracking credits associated with a gameplay session at a gaming device 108. In some other cases, the data structures 201 may be used in connection with tracking credits earned and/or credits lost at a gaming device 108 in association with an invoked auto play mode, a playstyle model applied to the auto play mode, etc.

In some embodiments, the data stored in the data structure 201 may be stored for a plurality of different tickets/vouchers and may or may not be organized based on events, player association, etc. As a non-limiting example, the data structure 201 may be used to store ticket/voucher status information, ticket/voucher value information, and the like. The ticket/voucher value information may include credit information associated with a gameplay session at a gaming device 108.

In an example, the data structure 201 may include a plurality of data fields that include, for instance, a ticket/voucher number field 224, an issued amount field 228, an issued date/time field 232, an issuing device field 236, a redeeming device field 240, a redeem date/time field 244, a redemption value field 248, and a ticket/voucher state field 252. It should be appreciated that the data structure 201 may have greater or fewer fields than depicted in FIG. 2B.

The ticket/voucher number field 224 may be used to store a unique validation number assigned to the ticket/voucher when a ticket/voucher is issued to a player 112. In some embodiments, the data stored in the ticket/voucher number field 224 may be randomly generated, pseudo-randomly generated, or sequentially generated based on when the ticket/voucher is issued. In some embodiments, the validation number assigned to the ticket/voucher may be unique to the ticket/voucher within the gaming system 100 (e.g., at least unique as to any other ticket/voucher issued within the gaming system 100). While numeric values may be used for the validation number, it should be appreciated that any alphanumeric string may be used for the validation number stored in the ticket/voucher number field 224.

The issued amount field 228 may be used to store an electronic record of a monetary value for which the particular ticket/voucher was issued. The issued amount field 228 may correspond to a data field that is written once and not updated. Thus, even when an associated ticket/voucher transitions from the issued state to another state, the value recorded in the issued amount field 228 may be left unchanged. Likewise, the information stored in the issued date/time field 232 and issuing device field 236 may also be written once and not changed thereafter. The issued date/time field 232 may store information describing when a ticket/voucher is issued, whereas the issuing device field 236 may store information describing where a ticket/voucher is issued. For instance, the issuing device field 236 may indicate a unique serial number assigned to a gaming device 108 that was used to issue the ticket/voucher to the player 112 and the issued date/time field 232 may store the time at which the ticket/voucher was issued by the gaming server 116 and/or the gaming device 108.

In some embodiments, the date/time field 232 may be populated based on a clock of the gaming device 108 that issued the ticket/voucher rather than relying on the clock of the gaming server 116. Said another way, when a gaming device 108 issues a ticket/voucher, such information may be communicated back to the gaming server 116 along with a timestamp provided by the gaming device 108 to indicate a time at which the gaming device 108 issued the ticket/voucher. Using the time indicated by the gaming device 108 can help account for or avoid problems associated with delays in communication over the communication network 104. One such possible problem would be having a wagered event (e.g., a sporting event) come to completion while the communication network 104 is down or unavailable and before the gaming server 116 becomes aware of an issued ticket/voucher by a gaming device 108. Alternatively, or additionally, it may also be possible or desirable to use the clock of the gaming server 116 as the centralized authority on all date/times entered into the field 232, thereby avoiding the need to synchronize or consider synchronization issues between different gaming devices 108.

Like the issuing device field 236, the redeeming device field 240 may be used to store information describing a device at which a ticket/voucher is redeemed by a player 112. Alternatively, or additionally, the redeeming device field 240 may be used to store information describing a communication device 145 via which a player 112 may redeem credits associated with a gameplay session or a player profile. In some embodiments, a device used for redeeming a ticket/voucher or credits may correspond to a gaming device 108 or a communication device 145.

A player 112 may redeem a ticket/voucher at a gaming device 108 by inserting a printed ticket/voucher into a ticket acceptance device of the gaming device 108 (e.g., similar to a bill acceptor). A player 112 may redeem a ticket/voucher at a communication device 145 by scanning the ticket/voucher with a camera of the communication device 145 and transmitting information obtained from the scan of the ticket/voucher back to the gaming server 116 as proof of redemption. Alternatively, or additionally, in the example case of an electronic ticket/voucher (e.g., an e-TITO voucher), a player 112 may to redeem the electronic ticket/voucher at a gaming device 108 or a communication device 145 by using an RFID reader that is in electronic communication with (e.g., electrically coupled to) the gaming device 108 or the communication device 145.

Thus, the redeeming device field 240 may store information uniquely describing the device used by the player 112 to redeem a ticket/voucher (e.g., an address or device ID). Alternatively or additionally, the redeeming device field 240 may store information describing a type of device that was used for redemption (e.g., whether the device is a gaming device 108 or a communication device 145).

The redemption date/time field 244, similar to the issued date/time field 232, may be used to store data and/or time information for the ticket/voucher. For example, the redemption date/time field 244 may be used to store a date/time when a ticket/voucher is redeemed as opposed to when the ticket is issued. Again, the time indicated in the field 244 may be based on a timestamp issued by the redeeming device and/or a clock of the gaming server 116. The date/time provided in the data field 244 may correlate to a date/time when the state of the ticket transitions within the ticket/voucher state field 252.

When the electronic record of the ticket/voucher state 252 is updated, a change to the date/time in field 244 may also be made at substantially the same time. As will be discussed in further detail herein, the ticket/voucher state field 252 may be used to store state or status information for a ticket/voucher and the state within the field 252 may be capable of having at least three different values (e.g., issued, redeemable, and redeemed). Other possible values for the state of the ticket/voucher may include, without limitation, a pending state, which may correspond to a state between the issued state and the redeemable state where a wagered event has come to completion but the redeemable value of the ticket/voucher is still being determined and/or considered.

The redemption value field 248 may be used to store an electronic record indicating an amount for which a ticket/voucher may be redeemed (e.g., a redeemable value) and/or an amount for which a ticket/voucher is actually redeemed (e.g., a redeemed/redemption amount). In embodiments where the redeemable value is the same as the redeemed/redemption value, there may only need to be a single data field 248 to store the redemption value for the ticket/voucher. In some embodiments, it may also be desirable to have separate data fields to store a redeemable value for a ticket/voucher and then a redeemed/redemption value for the ticket/voucher. The redeemable value for a ticket/voucher may be determined by the gaming server 116 as soon as the wagered event for which the ticket/voucher is associated has come to completion whereas the redemption value may be determined by the gaming server 116 when the ticket/voucher is redeemed. Again, the redemption value may be the same as or different from the redeemable value without departing from the scope of the present disclosure.

With reference to FIG. 2C, details of data structure 202 that may be maintained as part of a gaming device profile will be described in accordance with at least some embodiments of the present disclosure. The gaming device database 154 may be configured to store one or multiple data structures 202 that are used in connection with tracking a gameplay mode of a gaming device 108. In some embodiments, the data stored in the data structure 202 may be stored for a plurality of different gaming devices 108 or a single gaming device 108. As a non-limiting example, the data structure 202 may be used to store gaming device information, and the like. Even more specifically, the data structure 202 may include a plurality of data fields that include, for instance, a gaming device information field 256, a gaming system information field 258, a representative player behavior model field 260, a secondary game prediction model field 262, and a player demographic prediction model field 264.

The gaming device information field 256 may be used to store any type of information that identifies a gaming device 108 or a group of gaming devices 108. In some embodiments, the gaming device information field 256 may store identification information for a gaming device 108 (e.g., a unique serial number assigned to the gaming device 108) and any other type of gaming device management data that may be stored with respect to a gaming device 108.

The gaming system information field 258 may be used to store any type of gameplay and other gaming information including granular and/or summarized gameplay data, gaming system (e.g., casino floor) map showing gaming device location and current usage (e.g., heat map), and the like.

The representative player behavior model field 260 may store representative user decisions and predictions and hyperparameters and tunable parameters and may include a list of representative player behavior models. For example, the representative player behavior model field 260 may include a list of stored representative player behavior models (e.g., stored at the memory 124 of the gaming server 116, stored at the player profile database 148, stored at the gaming device database 154, etc.).

The secondary game prediction model field 262 may store secondary game predictions and hyperparameters and tunable parameters associated with the secondary game prediction model.

The player demographic prediction model field 264 may store player demographic prediction model decisions or predictions and hyperparameters and tunable parameters.

In some aspects, the representative player behavior model, secondary game prediction model, and player demographic model fields 260, 262, and 264 may store data (e.g., characteristics, features, use history, modifications, etc.) associated with the respective model. For example, the fields 260, 262, and 264 may store data associated with baseline models, modified versions of the models, or the like. In some examples, the fields may store accuracy information associated with decisions and predictions generated by the model with respect to an action or event (e.g., for the representative player behavior model (average speed of play, cash in amount, cash out amount, play session length, additional in-session cash in amounts, wager behavior, wagering speed, and idle time for the group of players represented), for the secondary game prediction model (player behavior responsive to execution of a secondary game), and for the player demographic prediction model (player behavior responsive to execution of a secondary game).

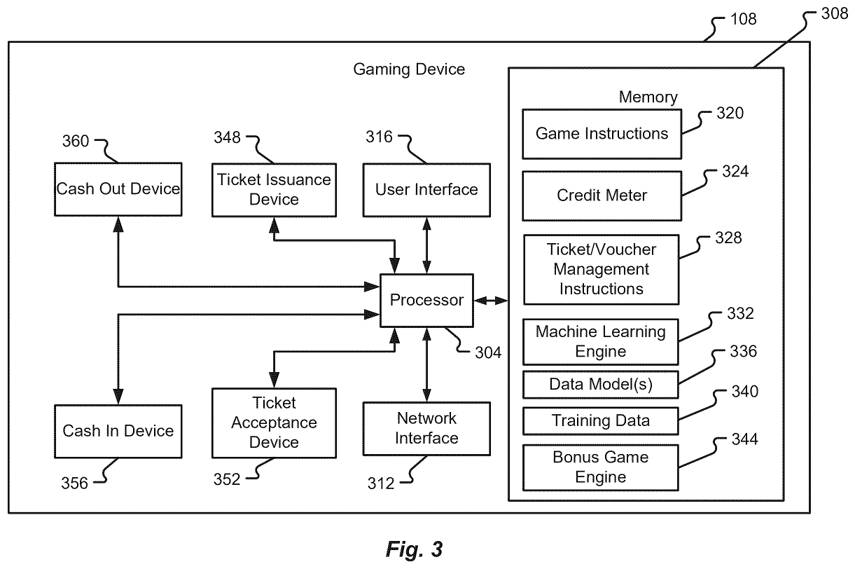

With reference now to FIG. 3, additional details of a gaming device 108 will be described in accordance with at least some embodiments of the present disclosure. While depicted as a gaming device 108, it should be appreciated that some or all of the components of the gaming device 108 may be included in a mobile device described herein without departing from the scope of the present disclosure.

The gaming device 108 is depicted to include a processor 304, memory 308, a network interface 312, a user interface 316, a ticket issuance device 348, a ticket acceptance device 352, a cash-in device 356, and a cash-out device 360. In some embodiments, the processor 304 may include example aspects of the processor 120. In other words, the processor 304 may correspond to one or many microprocessors, CPUs, GPUs, microcontrollers, or the like. The processor 304 may be configured to execute one or more instruction sets stored in memory 308.

The network interface 312 may include example aspects of network interface 128. The nature of the network interface 312, however, may depend upon whether the network interface 312 is provided in a gaming device 108 or a communication device 145. Examples of a network interface 312 include, without limitation, an Ethernet port, a USB port, an RS-232 port, an RS-485 port, a NIC, an antenna, a driver circuit, a modulator/demodulator, etc. The network interface 312 may include one or multiple different network interfaces depending upon whether the gaming device 108 is connecting to a single communication network 104 or multiple different types of communication networks 104. For instance, the gaming device 108 may be provided with both a wired network interface and a wireless network interface without departing from the scope of the present disclosure.

The user interface 316 may correspond to any type of input and/or output device that enables the player 112 to interact with the gaming device 108. As can be appreciated, the nature of the user interface 316 may depend upon the nature of the gaming device 108. For instance, if the gaming device 108 is a traditional mechanical reel slot machine, then the user interface 316 may include one or more mechanical reels with symbols provided thereon, one or more lights or LED displays, one or more depressible buttons, a lever or “one armed bandit handle”, a speaker, or combinations thereof. If the gaming device 108 is a digital device, then the user interface 316 may include one or more touch-sensitive displays, LED/LCD display screens, etc. In some cases, the user interface 316 may include a combination of a physical interface (e.g., mechanical reels, depressible buttons, a lever, etc.) and other user interfaces (e.g., touch-sensitive displays, LED/LCD display screens, etc.). In some cases, the user interface 316 may include a biometric scanning device (e.g., a fingerprint scanner) supportive of biometric inputs by a user.

The memory 308 may include example aspects of memory 124. For instance, the memory 308 may include one or multiple computer memory devices that are volatile or non-volatile. The memory 308 may be configured to store instruction sets that enable player interaction with the gaming device 108, that enable game play at the gaming device 108, and/or that enable coordination with the gaming server 116. Examples of instruction sets data that may be stored in the memory 308 include a game instruction set 320, a credit meter 324, a ticket/voucher management instruction set 328, and secondary game engine 344.

In some embodiments, the game instruction set 320, when executed by the processor 304, may enable the gaming device 108 to facilitate one or more games of chance or skill and produce interactions between the player 112 and the game of chance or skill. In some embodiments, the game instruction set 320 may include subroutines that present one or more graphics to the player 112 via the user interface 316, subroutines that calculate whether a particular wager has resulted in a win or loss during the game of chance or skill, subroutines for determining payouts for the player 112 in the event of a win, subroutines for exchanging communications with a connected server (e.g., game management server, gaming server 116, or the like), subroutines for enabling the player 112 to engage in a game using their communication device 145, and any other subroutine or set of instructions that facilitate gameplay at or in association with the gaming device 108.

In some aspects, the game instruction set 320, when executed by the processor 304, may enable the gaming device 108 to call or utilize the secondary game engine 344. For instance, as part of determining a secondary game preference, the game instruction set 320 may interact with the secondary game engine 344 to monitor actions (e.g., in-game and non-game actions) during a gaming session, determine whether any such actions correspond to a secondary game preference, correlate secondary game preference(s) to a particular secondary game and/or secondary game attributes, configure a default secondary game with one or more secondary game attributes and/or present secondary game to player 112. The secondary game engine 344 may also be configured to interact with the gaming server 116 by utilizing data model(s) 142 stored thereon (e.g., secondary game preference model) and/or by retrieving player action history 144 for the player involved in the gaming session.

The credit meter 324 may correspond to a secure instruction set and/or data structure within the gaming device 108 that facilitates a tracking of activity at the gaming device 108. In some embodiments, the credit meter 324 may be used to store or log information related to various activities of a player 112 and events that occur at the gaming device 108. The types of information that may be maintained in the credit meter 324 include, without limitation, player information, available credit information, wager amount information, and other types of information that may or may not need to be recorded for purposes of accounting for wagers placed at the gaming device 108 and payouts made for a player 112 during a game of chance or skill played at the gaming device 108.

In some embodiments, the credit meter 324 may be configured to track coin in activity, coin out activity, coin drop activity, jackpot paid activity, bonus paid activity, credits applied activity, external bonus payout activity, ticket/voucher in activity, ticket/voucher out activity, timing of events that occur at the gaming device 108, and the like. In some embodiments, certain portions of the credit meter 324 may be updated in response to outcomes of a game of chance or skill played at the gaming device 108. In some embodiments, the credit meter 324 may be updated depending upon whether the gaming device 108 is issuing a ticket/voucher, being used as a point of redemption for a ticket/voucher, and/or any other activity associated with a ticket/voucher. Some or all of the data within the credit meter 324 may be reported to the gaming server 116, for example, if such data applies to a centrally-managed game and/or a status of a ticket/voucher. As an example, the number, value, and timing of wagers placed by a particular player 112 and payouts on such wagers may be reported to the gaming server 116.

Activities of the gaming device 108 related to ticket/voucher activity may be managed and reported by the ticket/voucher management instruction set 328. In some embodiments, when a ticket/voucher is redeemed at the gaming device 108 by the player 112, information associated with the ticket/voucher may be obtained by the ticket/voucher management instruction set 328 and reported to the gaming server 116. Furthermore, the ticket/voucher management instruction set 328 may be configured to update the credit meter 324 if the redeemed ticket/voucher is determined to be in a redeemable state and has a redeemable or redemption value associated therewith. In some embodiments, the credit meter 324 may be updated or incremented by the redeemable or redemption value of the ticket/voucher when redeemed. This information may be obtained directly from the ticket/voucher or may include some interactions (e.g., verification operations) with the gaming server 116 prior to updating the credit meter 324.

The gaming device 108 may be provided with appropriate hardware to facilitate acceptance and issuance of tickets/vouchers. Specifically, the gaming device 108 may be provided with a ticket acceptance device 352 that is configured to accept or scan physically-printed tickets/vouchers and extract appropriate information therefrom. In some embodiments, the ticket acceptance device 352 may include one or more machine vision devices (e.g., a camera, IR scanner, optical scanner, barcode scanner, etc.), a non-visual scanning device (e.g., an RFID reader, an NFC reader), a physical ticket acceptor, a shredder, etc. The ticket acceptance device 352 may be configured to accept physical tickets and/or electronic tickets without departing from the scope of the present disclosure. An electronic ticket/voucher may be accepted by scanning a visual code (e.g., a one-dimensional barcode, a two-dimensional barcode, any other type of barcode, a quick response (QR) code, etc.) displayed on a printed ticket/voucher or a communication device 145, for example. In another example, an electronic ticket/voucher may be accepted by scanning a tag (e.g., an RFID tag, an NFC tag, a contactless smart card, or the like) storing the ticket/voucher information.

The ticket issuance device 348 may be configured to print or provide physical tickets/vouchers to players 112. In some embodiments, the ticket issuance device 348 may be configured to issue a ticket/voucher consistent with an amount of credit available to a player 112, possibly as indicated within the credit meter 324. In some cases, the ticket/voucher may be an e-TITO voucher including a reprogrammable electronic display and an RFID tag.

The cash-in device 356 may include a bill acceptor, a coin acceptor, a chip acceptor or reader, or the like. In some embodiments, the cash-in device 356 may also include credit card reader hardware and/or software. In some aspects, the cash-in device 356 may include one or more machine vision devices (e.g., a camera, IR scanner, optical scanner, barcode scanner, etc.) or non-visual scanning devices (e.g., an RFID reader/writer, an NFC reader/writer).

The cash-out device 360, like the ticket issuance device 322, may operate and issue cash, coins, tokens, or chips based on an amount indicated within the credit meter 324. In some embodiments, the cash-out device 360 may include a coin tray or the like and counting hardware configured to count and distribute an appropriate amount of coins or tokens based on a player's 112 winnings or available credit within the credit meter 324. In some aspects, the cash-out device 360 may include one or more machine vision devices or non-visual scanning devices.

The memory 308 may be configured to store instruction sets, neural networks, and other data structures (e.g., depicted herein) in addition to temporarily storing data for the processor 304 to execute various types of routines or functions. For example, the memory 308 may be configured to store program instructions (instruction sets) that are executable by the processor 304 and provide functionality of a machine learning engine 332 described herein. The machine learning engine 332 may include example aspects of the machine learning engine 141 described with reference to FIG. 1.

One example of data that may be stored in memory 308 for use by components thereof is a data model(s) 336 and/or training data 340. The data model(s) 336 and the training data 340 may include examples of aspects of the data model(s) 142 and the training data 143 described with reference to the gaming server 116. The gaming device 108 (e.g., the machine learning engine 332) may utilize one or more data models 336 for recognizing and processing information obtained by the gaming device 108, another gaming device 108, a server (e.g., the gaming server 116), communication devices 145, and/or a database (e.g., player profile database 148, ticket/voucher database 152, and/or gaming device database 154). In some aspects, the gaming device 108 (e.g., the machine learning engine 332) may update one or more data models 336 based on learned information included in the training data 340.

In some aspects, components of the machine learning engine 332 may be provided in a separate machine learning engine (e.g., at server, for example, the gaming server 116) in communication with the gaming device 108.

In the following description of the methods, the operations may be performed in a different order than the order shown, or the operations may be performed in different orders or at different times. Certain operations may also be left out of a method, or other operations may be added to a method. It is to be understood that any device (e.g., a gaming device 108, a gaming server 116, a communication device 145, components of the system 100, etc.) may perform the operations depicted and described herein.

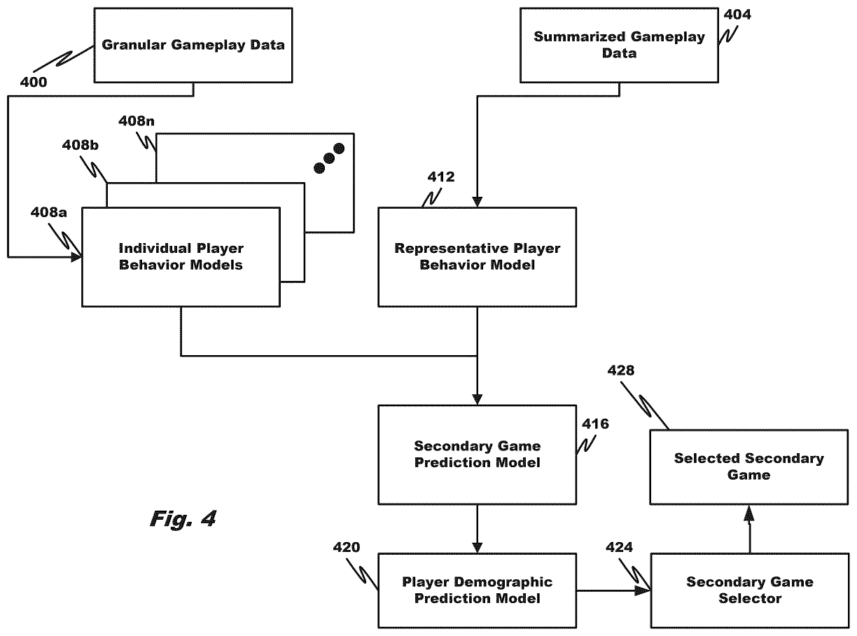

With reference to FIG. 4 in some examples, the player history may include granular data 400 based on each gameplay action tracked by a gaming device (e.g., spin level) during a gameplay session. The granular data, or attributes or instances or feature vectors, can be extracted from EGM/VLT logs and data and, for each gameplay session, include, for example: total cash in amount (the total amount of money inserted by the player in the machine during a play session), average primary wager, standard deviation of primary wager, number of distinct primary wagers, number of primary wagers, total (sum of) primary wagers, session length (elapsed time is the amount of time that passes from the start of a session to the end of the session), number of games played (number of different primary themes played in a session), number of times the bonus was experienced (number of secondary games played in a session), possibility of cashing out after hitting a bonus in the game (this value states whether a player cashes out after winning a bonus or not), possibility of changing the game after hitting a bonus in the game (this value states whether a player changes a game after winning a bonus or not), available cash (bank) wager correlation (correlation between wager amount and available cash; available cash is the current credit amount available to the player on an EGM (i.e., amount to be paid if the player decided to cash out)), average time between spins (average of the time difference between consecutive spins), standard deviation of time between spins (standard deviation of the time difference between consecutive spins), total cash out, total primary win (sum of all wins resulting from primary spin), average primary win (average win per spin), average secondary wager (average wagers for secondary games in a session), average secondary win (average wins for secondary games in a session), sum of secondary win (total of wins in secondary games in a session), starting cash in (total amount of cash in at the start of the session before he starts playing), additional cash in (total amount of additional cash in after a player starts playing), coin-in to coin-out ratio (coin-in is the total wagers made in a session. coin-out is the total of how much a player has been paid back on those wagers (total winnings)), net loss (the difference between total wagers and total winnings (coin-in—coin-out) in a session), % Loss (the net loss divided by the total wagers), intensity (e.g., wagers per minute in a gameplay session), time of the day segment day/evening (a flag 1 or 0 to specify whether a session was during lunch time or not), cash out occurrence flag (flag to specify whether a player cashed out or ran out of money), cash out to cash in ratio (ratio of cash out to cash in), post loss (ratio of primary wager after a loss to the primary wager before), post win (ratio of the primary wager after a win to the primary wager before), primary wager changes (number of times a player changes primary wager), number of cash ins (number of times a player inserted money in a machine), average cash in, wager to cash in (ratio of the average primary wager to average cash), tradeoff (ratio of average win in primary over average primary wager), secondary to primary (ratio of secondary wager to primary wager), wager to bank ratio (average of the ratio of wager to available cash), primary wager changes/no games, maximum cash in, cash in separated by ticket, note and coin, number of cash outs, max cash out, number of primary wins, list of played games including number of plays, and list of played denominations including number of plays.

Granular data that indicates a player behavior associated with a like or dislike of a secondary game and can be used to configure a secondary game for the tracked player includes, without limitation, data structures in temporal proximity to the secondary game execution that indicate a player action approving or disapproving the secondary game. Such granular data includes the player cashing out, the player increasing a wager, the player continuing the play the game in the current gaming session, and the like.

In some aspects, the machine learning engine 141 may use a data model 408-a-n (also referred to herein as a player behavior model) configured to calculate or determine a gameplay behavior of a selected player with respect to different gameplay events, gameplay decisions, gameplay results, gameplay durations, etc. Each player 112 n has a corresponding individual player behavior model 142-a-n. For example, the machine learning engine 141 may use the data model 408a to calculate or determine the response (e.g., post bonus behavior) of the corresponding player to playing or earning a bonus game, jackpot, secondary bonus game, or other gameplay reward and/or reward program offering, using gameplay data (e.g., decision events, gameplay decisions, gameplay results, etc.) such as the attributes set forth above and sensor data (e.g., biometric data, pressure sensor data, etc.). The response relates typically to a level of intensity or increased play engagement by the respective player in response to earning a bonus game, jackpot, secondary bonus game, or other gameplay reward and/or reward program offering. The player behavior model can be for a type of gaming device (e.g., EGM or EGT) and/or type of game (e.g., slots, roulette, blackjack, poker, keno, etc.).

The gameplay data may include data received not only from a gaming device 108 but also from each player's communication device 145. This is particularly useful in gaming systems enabling gaming sessions to be played not only on gaming devices but also on communication devices.

In some aspects, the machine learning engine 141 may use a data model 412 (referred to herein as a representative player behavior model) configured to calculate or determine a representative gameplay behavior of a group of players with respect to different gameplay events, gameplay decisions, gameplay results, gameplay durations, etc. For example, the machine learning engine 141 may use the data model 412 to calculate or predict the representative response (e.g., representative post bonus behavior) of the group of players to earning or playing a bonus game, jackpot, secondary bonus game, or other gameplay reward and/or reward program offering, using aggregated gameplay data (e.g., decision events, gameplay decisions, gameplay results, etc.) such as the attributes set forth above. The representative player behavior can be based on summarized gameplay data 404 over a selected time period derived from mathematically combining (e.g., averaging) multiple values of a selected attribute for different players in the group (over multiple gameplay sessions) to provide a representative value for the group of players as a whole. The representative response relates typically to a level of intensity or increased play engagement by a representative player in a group of players in response to earning a bonus game, jackpot, secondary (bonus) game, or other secondary gameplay reward and/or reward program offering.

The representative player behavior can be based on the summarized gameplay data 404 from currently active players and/or model parameters and/or model output associated with the selected players currently playing at the gaming devices in the gaming system. A baseline representative player behavior model can be modified using the summarized gameplay data 404 from selected currently active players. The model parameters, for example, from the individual player behavior models of the selected currently active players could be mathematically combined (e.g., averaged) for the representative player representing the selected currently active players. The representative player behavior model can be for a type of gaming device (e.g., EGM or EGT) and/or type of game (e.g., slots, roulette, blackjack, poker, keno, etc.). While the representative player behavior model could be replaced with multiple outputs from the player behavior models of a selected group of active players, the processing resources required for such real time processing and comparisons can be prohibitive.

In some aspects, the summarized gameplay data 404 comprises attributes more generalized than those set forth above. In some embodiments, the summarized gameplay data 404 is mathematically derived (e.g., by averaging or otherwise aggregating) over a selected time interval from the values of each of the data fields for all gameplay sessions of a group of gaming devices. In other embodiments, fewer or consolidated fields are used. Exemplary attributes for summarized performance data for each gaming device over a selected time period include record identifier (Recordid), upload time stamp (UploadTimestamp), gaming device identifier (e.g., MachineSerialNumber), pull local timestamp (PullLocalTimestamp), vendor (e.g., casino) name (VendorName), (casino) currency code (CurrencyCode), game identifier (Gameld), game name (GameName), denomination (Denomination), return to player (Rtp) base percentage RtpBasePercentage), total coin in credits (TotalCoinInCredits), total jackpot credits (TotalJackpotCredits), pull date (PullDate), time since previous pull (TimeSincePreviousPull), total coin in currency (TotalCoinInCurrency), total coin out currency (TotalCoinOutCurrency), total jackpot currency (TotalJackpotCurrency), total net win currency (TotalNetWinCurrency), total theoretical win currency (TotalTheoreticalWinCurrency), total games played (TotalGamesPlayed), total players played (TotalPlayersPlayed),and the like.

Regardless of whether the individual player behavior model 408 or representative player behavior model 412 is employed, the model output includes a set of multiple player secondary game preferences (e.g., secondary game likes and/or dislikes) with a corresponding probability of the one or more members of the determined set of player secondary game preferences being correct. The preferences can be mapped to a secondary game configuration option, including those discussed above. By way of illustration, such options include secondary game appearance and mechanics configuration options, gameplay affecting and/or non-gameplay affecting configuration options, and/or payout-relevant and non-payout-relevant configuration options. The probability associated with the output could be used as an indicator of the degree to which the selected player likes or dislikes secondary gameplay (e.g., the probability that the player's primary factor in primary game selection is the associated secondary game.

In some aspects, the machine learning engine 141 may use a secondary game prediction data model 416 configured to calculate or predict, based on the output of the individual or representative behavior model, a plurality of fully configured secondary games with each game having an associated probability of satisfying the player's secondary game preferences. A baseline secondary game prediction data model 416 can be modified or trained using the observed player behavior in response to executing a selected one of the plurality of configured secondary games using granular or summarized gameplay data 404 collected for the selected player in temporal proximity to executing the selected one of the plurality of configured secondary games.

In some aspects, the machine learning engine 141 may use a player demographic game prediction model 420 configured to increase or decrease the probability assigned to any of the plurality of configured secondary games based on demographics 420 of the selected player or group of players. As used herein, “player demographics” refers to one or more characteristics of the selected player that have been categorized by distinct criteria, such as age, birth gender, socioeconomic status, and income. A baseline player demographic prediction data model 420 can be modified or trained using the observed player behavior in response to executing a selected one of the plurality of configured secondary games using granular or summarized gameplay data 404 collected for the selected player in temporal proximity to executing the selected one of the plurality of configured secondary games.

The output of the player demographic prediction model 420, which is the plurality of configured secondary game preferences with an adjusted probability for one or more of the associated probabilities, is provided to the secondary game selector 424, which selects a selected secondary game 428 for the selected player using a randomized algorithm to avoid repetition and provide secondary game variety to the player. In one configuration, the randomized algorithm employs random number or pseudorandom number generation, or a generated sequence of numbers or symbols to select a secondary game having at least a threshold associated probability. In another configuration, random sampling or reservoir sampling is performed among the secondary games having at least a threshold probability. As will be appreciated, other random selection algorithms may also be employed.

The machine learning engine 141 may generate, train, retrain, and/or modify the various data models 408 and 412 using subsequent gameplay and, in the case of the secondary game and player demographic prediction models 416 and 420 granular gameplay or summarized gameplay data 400 and 404 to identify player behavior responsive to execution of the selected secondary game 428.

While any AI model can be used for the models 408, 412, 416, and 420, a preferred AI model for models 408, 412, and 416 is a large language model (LLM) or neural network trained with time series data in a timely manner. As will be appreciated, a time series is a series of data points indexed in time order in a constant interval of time, where time acts as an independent variable and one or more associated measurements acts as dependent variables. Time series data typically include four constituent parts, namely level or baseline value, trend of selected player secondary game behavior (whether increasing or decreasing behavior over time), seasonality (repeating patterns or cycles of selected player secondary game behavior over time), and noise (variability in the selected secondary game behavior that cannot be explained by the model). In the present disclosure, the time series is a multivariate time series. Examples of machine learning algorithms that may be employed include linear regression, XGBoost, random forest, decision trees, deep learning models (such as Recurrent Neural Network (RNN) and Long Short-Term Memory (LSTM)), or any machine learning model with reduction methods.

Dimensionality reduction can be performed, for instance, by decreasing the number of secondary game features monitored and/or decreasing the sample size analyzed (e.g., shortening the time window or focusing on secondary game chasers or hunters). Unsupervised machine learning algorithms are particularly preferred as they enable dimensionality reduction through clustering to identify players having specific behaviors (e.g., secondary game chasers). Time indexing can be particularly beneficial as it orders gameplay sessions and enables the model to recognize when a new secondary game is introduced and, as new secondary games are introduced, to account for decreased player desire to play a given type or configuration of secondary game.

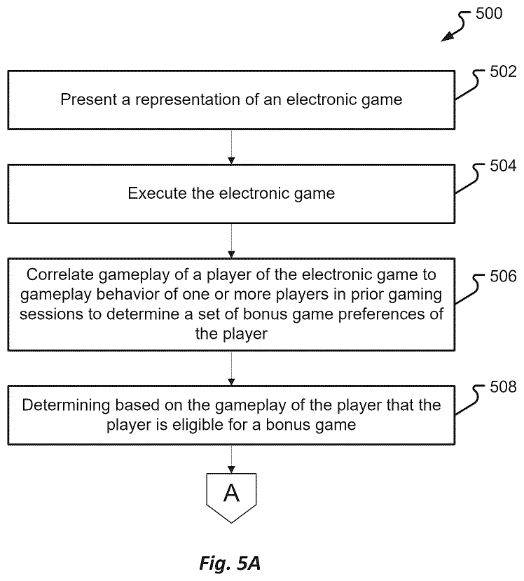

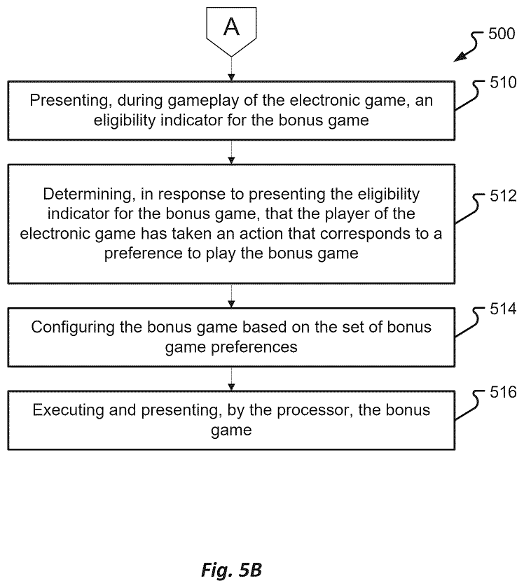

Referring now to FIGS. 5-9, example methods that support aspects of the present disclosure associated with detecting a secondary game preference and enabling presentation of a preferred secondary game determined, in whole or in part, by the secondary game preference. In some examples, some or all of a method may be performed at a single device (e.g., gaming server 116 or gaming device 108). Alternatively, a method may be performed by the cooperation of multiple devices without departing from the scope of the present disclosure.

FIGS. 5A and 5B illustrate a first and second portion, respectively, of process flow 500 that illustrating aspects of the present disclosure associated with determining of player actions indicating a secondary game preference. The process flow 500 supports aspects of the present disclosure associated with a player's behavior applied to a gameplay session. In some examples, process flow 500 may implement aspects of gaming system 100. Further, process flow 500 may be implemented by a gaming system 100 or components included therein as described with reference to FIGS. 1 through 4.

At 502 of FIG. 5A a representation of an electronic game is presented. In some aspects, the presentation of the electronic game is an icon, text, graphics, animation, sounds, lights, or simulated gameplay of the electronic game that may cause a player 112 to identify the electronic game and/or attract a player 112 to play the electronic game. In some examples, presenting a representation of an electronic game comprises presenting representations of a plurality of electronic games available for selection by receiving an input form a player. The representations of the plurality of electronic games may be presented serially, in parallel, or a combination of both. In aspects wherein a representation of a single electronic game is presented for a period of time or in response to player 112 providing an input to see another electronic game, presenting another representation of an electronic game. In aspects wherein a representation of a plurality of games is presented, a player 112 input may scroll through the options of available electronic games and select a preferred electronic game as a primary game to play. Additionally or alternatively, representations of the electronic game may include representations of one or more secondary games available within gameplay of the electronic game. In some aspects, the representations of the electronic game are presented by a display device of, or operated by, gaming device 108.

At 504 the electronic game is executed. In some aspects, execution of the electronic game may be triggered by a player 112 selecting one electronic game from a plurality of electronic games presented (step 502). In some aspects, execution of the electronic game occurs upon player 112 selecting to apply a wager credit to play the electronic game.

At 506 gameplay of the player 112 is correlated with gameplay behavior of one or more players in prior gaming sessions to determine a secondary game preference of the player 112.

In some aspects, the one or more players in prior gaming sessions have a known secondary game preference and one or more prior player attributes. The prior player attributes include, but is not limited to, one or more of, a demographic attribute, gameplay pattern associated with a primary game, gameplay pattern associated with a different game, change in gameplay pattern upon being presented with an indication that one or more secondary games are available to play, change in gameplay pattern during gameplay of a secondary game, and change in gameplay pattern after the secondary game has concluded and play of the primary game has resumed. In some aspects, the correlation between player 112 and one or more players in prior gaming sessions is determined by a degree of match therebetween. In some examples, a match is present when the degree of match is within a standard deviation (e.g., one or two standard deviations). In another example, a match is present when the degree of match is at least that of a previously determined threshold.

In some embodiments, the secondary game preferences include a preference for a specific game over one or more other secondary games. Additionally or alternatively, the secondary game preferences include a modification to a previously determined secondary game. In some examples, the modification to the previously determined secondary game includes, but is not limited to, a theme, an appearance, a sound level, a sound feature, a light level, a light feature, a game objective, a level of player interactivity, a visual element, a level of presented urgency, a level of presented energy, a type of prize available, a value of prize available, a probability of winning, an ability to alter gameplay of the electronic game, or an ability to alter gameplay of a third secondary game. In some aspects, the secondary game prize that is available to be awarded to the player comprises a non-fungible token (NFT). Upon being awarded the NFT, the electronic game causes an ownership block for the token to be created that identifies the owner as player 112. The ownership block is then added to a blockchain or, when absent, create a new blockchain and added to the new blockchain. In other aspects, a machine-readable indicium of the NFT is provided such as a URL or QR code to enable the player 112 using communication device 145b to capture the indicium and create and add an ownership block of the NFT to a blockchain.

At 508, during gameplay of a primary game, the player 112 is determined to be eligible to play a secondary game. In some aspects, the primary game determines a secondary game is eligible upon the player 112 satisfying a criterion of wagering amount, frequency, duration, and/or accomplishing a bonus-determining task of the primary game.

Continuing to FIG. 5P, via off-page connector “A”, at step 510 during gameplay of the electronic game, an eligibility indicator for the secondary game is presented. As a result of step 510, player 112 may become aware that a secondary game. In some aspects, the presentation of the eligibility indicator indicates that a secondary game is available for selection and will be executed and presented by the electronic game in accordance with an input provided by player 112. Player 112 may be provided with the ability to refuse the secondary game. Refusal of a secondary game may terminate process flow 500. In some aspects, presentation of the eligibility indicator. In some aspects, step 510 announces the future execution of a secondary game, which may cause the electronic game to be more interesting and enjoyable to a player 112. The time between the announcement of the secondary game and the secondary game being presented and executed (see step 516) is variously embodied, such as a number of gameplays, wagers, wager amounts, time, and combinations thereof. Additionally or alternatively, the time between the announcement and presentation of the secondary game may be, in whole or in part, a random or pseudo-random value between previously determined high and low limits.

At step 512 the behavior of player 112 is observed in response, a determination is made as to whether player 112 has taken an action that corresponds to a preference to play a secondary game. In some aspects, the action that corresponds to a preference to play the secondary game may be determined solely by the actions of player 112. In some examples, player 112 takes an action comprising a change in wager amount, gameplay speed, and/or pausing gameplay.

At step 514 the secondary game is configured based on the set of secondary game preferences. At step 516 the secondary game is executed and presented to player 112. In some aspects, the execution and presentation of the primary game is paused, such as a designated stopping point, wherein the secondary game is executed and presented to player 112. Upon completion of the secondary game, the secondary game is terminated and execution and presentation of the primary game is resumed.

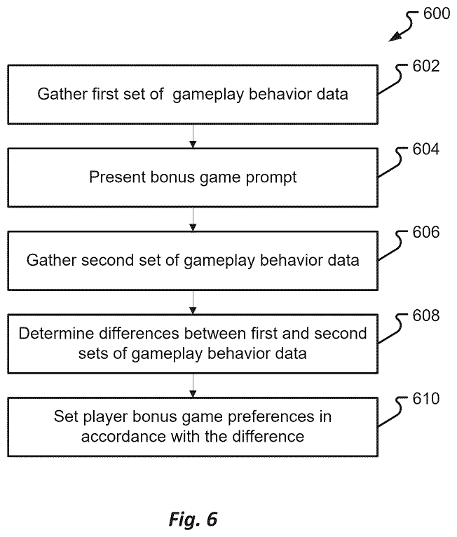

FIG. 6 illustrates process flow 600 supporting aspects of the disclosure associated with determining an action that indicates a player's secondary game preference. In some examples, process flow 600 may implement aspects of gaming system 100. Further, process flow 600 may be implemented by a gaming system 100 or components included therein as described with reference to FIGS. 1 through 4.

At 602 first set of gameplay behavior data is collected for a player 112. In some aspects, the first gameplay behavior includes data gathered during gameplay of one or more other games (e.g., electronic games, table games, sports book, etc.) for the player 112. Additionally or alternatively, the first set of gameplay behavior data includes data gathered during gameplay of the electronic game, such as a primary game, played by player 112. In yet another additional or alternative aspect, the first set of gameplay behavior data includes data gathered from other sources (e.g., questionnaire, affiliations with other businesses, interests, observations, etc.). In some examples, a questionnaire may explicitly ask for the secondary game preferences for player 112. In some other examples, such as obtained from a questionnaire or other source, player 112 may have an affiliation for a particular brand of automobiles and an interest in motor sports. Aspects of the first set of gameplay behavior data may include demographic information, level of attentiveness during gameplay, tolerance for risk, speed of play, wager amounts and betting patterns, excitement seeking or avoiding.

At step 604 a secondary game prompt is presented to a player during gameplay of an electronic game. In some aspects, the secondary game prompt may announce a particular secondary game selected from a pool of secondary games. Additionally or alternatively, the secondary game prompt may announce a particular configuration of a secondary game (e.g., a jungle theme secondary game, a secondary game with the theme determined by the player's affiliation for a particular brand of automobiles, a fast-paced secondary game, a high-energy secondary game, etc.).

At step 606, a second set of gameplay behavior data is gathered. The second set of gameplay behavior data may include one or more data elements of the first set of gameplay behavior data (step 602).

At step 608 a difference between the first set of gameplay behavior data and the second set of gameplay behavior data is determined. In some aspects, the difference between the first set of gameplay behavior data and the second set of gameplay behavior data indicates a level of interest exhibited by player 112 after presentation of the secondary game prompt (step 604). In some examples, the difference between the first set of gameplay behavior data and the second set of gameplay behavior data indicates an increase or decrease in gameplay speed, increase or decrease in wagered amount, and/or length of a pause between plays comprising gameplay.

At step 610 a player's secondary game preferences are set in accordance with the difference between the first set of gameplay behavior data and the second set of gameplay behavior data. Upon the electronic game triggering a secondary game, a secondary game determined, in whole or in party, in accordance with the player's 112 secondary game preferences is executed and presented. Additionally or optionally, the secondary game is determined in accordance with the player's 112 secondary game preferences periodically, randomly, and/or pseudo-randomly. In some examples, player 112 is presented with a preferred secondary game comprising a secondary game that is determined by their secondary game preferences every time a secondary game is presented or interspersed with other secondary games. Player 112 may find that interest in the primary game and/or secondary game is enhanced when there is uncertainty in knowing whether their next secondary game will be their preferred secondary game or a different secondary game.

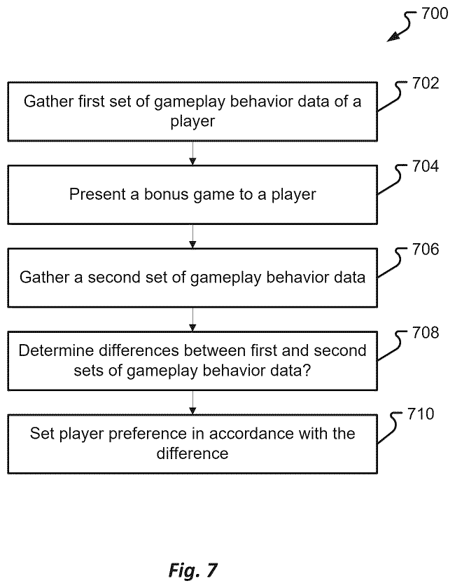

FIG. 7 illustrates process flow 700 supporting aspects of the disclosure associated with determining an action that indicates a player's secondary game preference after being presented with a secondary game. In some examples, process flow 700 may implement aspects of gaming system 100. Further, process flow 700 may be implemented by a gaming system 100 or components included therein as described with reference to FIGS. 1 through 4.

At 702 first set of gameplay behavior data is collected for a player 112. In some aspects, the first gameplay behavior includes data gathered during gameplay of one or more other games (e.g., electronic games, table games, sports book, etc.) for the player 112. Additionally or alternatively, the first set of gameplay behavior data includes data gathered during gameplay of the electronic game, such as a primary game, played by player 112. In yet another additional or alternative aspect, the first set of gameplay behavior data includes data gathered from other sources (e.g., questionnaire, affiliations with other businesses, interests, observations, etc.). In some examples, a questionnaire may explicitly ask for the secondary game preferences for player 112. In some other examples, such as obtained from a questionnaire or other source, player 112 may have an affiliation for a particular brand of automobiles and an interest in motor sports. Aspects of the first set of gameplay behavior data may include demographic information, level of attentiveness during gameplay, tolerance for risk, speed of play, wager amounts and betting patterns, excitement seeking or avoiding.

At 704 a secondary game is presented to a player 112. In some aspects, the secondary game will be determined, in whole or in part, in accordance with the secondary game preferences of player 112, in accordance with one or more players in prior gaming sessions, and/or by previously determined selection (e.g., random, pseudo-random, round-robin, etc.). The player 112 is then presented with the secondary game.

At 706 a second set of gameplay behavior data is gathered. In some aspects, the second set of gameplay behavior data is gathered during gameplay of the secondary game and/or after gameplay of the secondary game has ended. The second set of gameplay behavior data may include one or more data elements of the first set of gameplay behavior data (step 702).

At step 708 a difference between the first set of gameplay behavior data and the second set of gameplay behavior data is determined. In some aspects, the difference between the first set of gameplay behavior data and the second set of gameplay behavior data indicates a level of interest exhibited by player 112 after presentation of the secondary game (step 704). In some examples, the difference between the first set of gameplay behavior data and the second set of gameplay behavior data indicates an increase or decrease in gameplay speed, increase or decrease in wagered amount, and/or length of a pause between plays comprising gameplay.

At step 710 a player's secondary game preferences are set in accordance with the difference between the first set of gameplay behavior data and the second set of gameplay behavior data. Upon the electronic game triggering a secondary game, a secondary game determined, in whole or in party, in accordance with the player's 112 secondary game preferences is executed and presented. Additionally or optionally, the secondary game is determined in accordance with the player's 112 secondary game preferences periodically, randomly, and/or pseudo-randomly. In some examples, player 112 is presented with a preferred secondary game comprising a secondary game that is determined by their secondary game preferences every time a secondary game is presented or interspersed with other secondary games. Player 112 may find that interest in the primary game and/or secondary game is enhanced when there is uncertainty in knowing whether their next secondary game will be their preferred secondary game or a different secondary game.

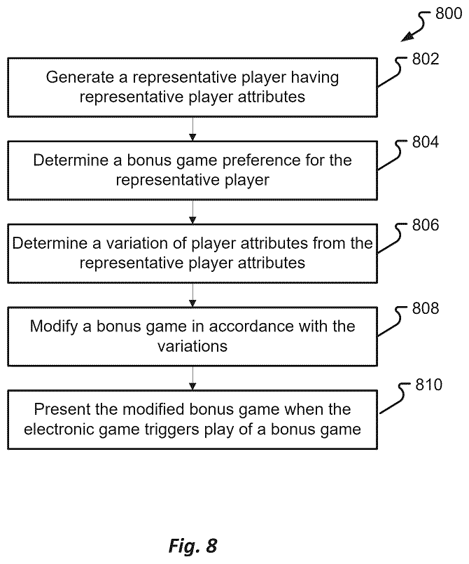

FIG. 8 illustrates process flow 800 supporting aspects of the disclosure associated with determining of a secondary game in accordance with a representative player attributes and variations therefrom by a player having player attributes. In some examples, process flow 800 may implement aspects of gaming system 100. Further, process flow 800 may be implemented by a gaming system 100 or components included therein as described with reference to FIGS. 1 through 4.

At 802 a representative player is generated having representative player attributes. In some aspects, the representative player attributes are consistent with a new player 112, such as a player whose identity is unknown and/or there is insufficient data. In other aspects, the representative player attributes are consistent with one or more players during prior gaming sessions having a correlated player attributes with the player attributes. In some examples, the representative player attributes and player attributes include demographics.

At 804 a secondary game preference is determined for the representative player. In some examples, the representative player is determined to have an affinity for a particular secondary game, selected from a plurality of secondary games, and/or a particular configuration of a secondary game (e.g., theme, speed, presented energy level, etc.).

At 806 a variation from the player attributes from the representative player attributes is determined. In some examples, the variation is a difference in the age, the risk tolerance, and the desire for peaceful gaming experiences.

At 808 the secondary game is modified in accordance with the variations (step 806). In some examples, the modification is the selection of a different secondary game from a secondary game that would be selected when there is less of a variation from the representative player. In other examples, the modification includes a different theme applied to an otherwise same game, the application of a different color palette, lowering or raising the audio output, and speed or slowing graphical elements.

At 810 the modified secondary game is presented to the player 112 when the electronic game triggers play of a secondary game.

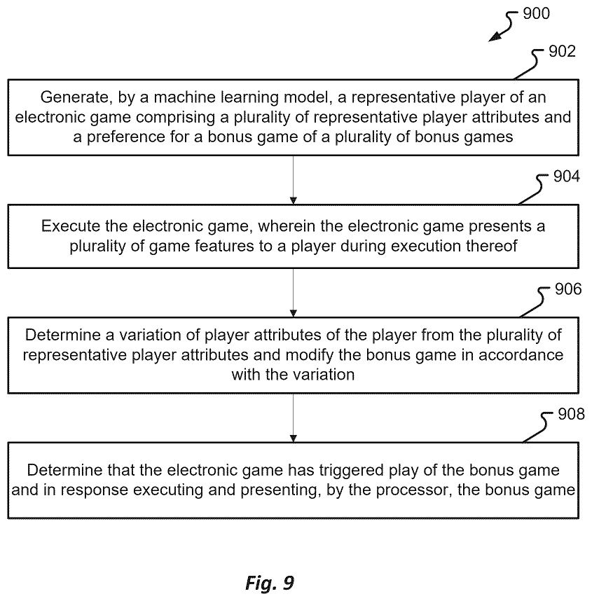

FIG. 9 illustrates process flow 900 supporting aspects of the disclosure associated with determining of a secondary game in accordance with a representative player attributes generated by a machine learning model. In some examples, process flow 900 may implement aspects of gaming system 100. Further, process flow 900 may be implemented by a gaming system 100 or components included therein as described with reference to FIGS. 1 through 4.

At 902 an artificial intelligence (AI), such as a machine learning model, generates a representative player of an electronic game to have representative player attributes. In some aspects, the representative player attributes comprise a preference for secondary games over no secondary games, a secondary game of a plurality of secondary games, and/or secondary game attributes.

In some aspects, the machine learning model is an unsupervised machine learning model wherein a prompt is generated and provided to the machine learning model. The prompt may include, but is not limited to, aspects of one or more players in prior gaming sessions, gameplay attributes of the one or more players, demographic attributes of the one or more players, secondary game preferences for the one or more players and a request for the machine learning model to determine a representative player based thereon.

In some aspects, the machine learning model is a supervised machine learning model trained on one or more training sets comprising, but not limited to, one or more players in prior gaming sessions, gameplay attributes of the one or more players, demographic attributes of the one or more players, secondary game preferences for the one or more players.

At 904, an electronic game is executed and presented to a player 112. The electronic game presents a plurality of game features to a player during execution of the electronic game.

At 906, a variation from the representative player and player 112 is determined.

At 906, the electronic game determines that a secondary game has been triggered and, in response, presents a secondary game to the player 112 that is a preferred secondary game and modified in accordance with variation of player 112 from the representative player.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method, comprising:
presenting, by a processor, a representation of an electronic game on a display device, wherein the representation of the electronic game includes displaying a plurality of game features;
executing, by the processor, the electronic game;
correlating gameplay of a player of the electronic game to gameplay behavior of one or more players in prior gaming sessions to determine a set of secondary game preferences of the player;
determining based on the gameplay of the player that the player is eligible for a secondary game;
presenting, during the electronic game, an eligibility indicator for the secondary game;
determining, in response to presenting the eligibility indicator for the secondary game, that the player of the electronic game has taken an action that corresponds to a preference to play the secondary game;
configuring the secondary game based on the set of secondary game preferences; and
executing and presenting, by the processor, the secondary game.

2. The method of claim 1, wherein the action that corresponds to the preference to play the secondary game further comprises determining, by the processor, that the player has altered a wagering pattern after presenting the eligibility indicator for the secondary game.

3. The method of claim 1, wherein the action that corresponds to the preference to play the secondary game further comprises determining, by the processor, that the player has altered a wagering pattern after presenting, by the processor, of one of a plurality of secondary games comprising the secondary game.

4. The method of claim 1, wherein the action that corresponds to the preference to play the secondary game further comprises determining, by the processor, that the player has altered a pattern of time of play of the electronic game after presenting of the eligibility indicator for the secondary game.

5. The method of claim 1, wherein presenting, by the processor, the eligibility indicator for the secondary game further comprises:
presenting the eligibility indicator for at least one of a first secondary game or a second secondary game; and
determining, by the processor, in response to presenting the eligibility indicator for at least one of the first secondary game or the second secondary game, that the player of the electronic game has taken the action that corresponds to a preference to play one of the first secondary game or the second secondary game; and
wherein executing and presenting the secondary game comprises executing and presenting one of the first secondary game or the second secondary game corresponding to the preference to play one of the first secondary game or the second secondary game.

6. The method of claim 5, wherein the preference to play one of the first secondary game or the second secondary game is determined, by the processor, providing one or more player attributes of the player to an artificial intelligence (AI) trained to determine the preference to play one of the first secondary game or the second secondary game.

7. The method of claim 5, wherein the preference to play one of the first secondary game or the second secondary game is determined, by the processor, by providing a prompt to an artificial intelligence (AI) and receiving therefrom the preference to play one of the first secondary game or the second secondary game, and wherein the prompt comprises one or more player attributes of the player, attributes of the first secondary game, attributes of the second secondary game, and a request to determine the preference of the player for either the first secondary game or the second secondary game.

8. The method of claim 5, wherein the first secondary game and the second secondary game differ in one or more of a type of game, a theme, an appearance, a sound level, a sound feature, a light level, a light feature, a game objective, a level of player interactivity, a visual element, a level of presented urgency, a level of presented energy, a type of prize available, a value of prize available, a probability of winning, an ability to alter gameplay of the electronic game, or an ability to alter gameplay of a third secondary game.

9. The method of claim 1, wherein determining, by the processor, that the electronic game has triggered play of the secondary game and the eligibility indicator for the secondary game is enabled, and in response, presenting, by the processor, a randomized secondary game from a plurality of secondary games that comprise the secondary game, and wherein the secondary game is weighted to be more likely to be presented as the randomized secondary game than any other one of the plurality of secondary games.

10. The method of claim 1, further comprising:
receiving, by the processor, a play result in response to presenting and executing the secondary game;
generating, by the processor, a non-fungible token corresponding to the play result; and
presenting, by the electronic game, a machine-readable indicum of the non-fungible token.

11. The method of claim 1, further comprising altering, by the processor, the secondary game to comprise at least one game feature of a next preferred secondary game.

12. A system, comprising:
a processor; and
a memory coupled with and readable by the processor and having stored thereon instructions which, when executed by the processor, cause the processor to:
execute an electronic game, wherein the electronic game presents a plurality of game features to a player during execution thereof;
correlate gameplay of the player in the electronic game to gameplay behavior of one or more players in prior gaming sessions to determine a set of secondary game preferences of the player;
determine, by a machine learning network, that the player has a preference to play a secondary game and in response, enabling play of the secondary game; and
determine, during the electronic game, that the player of the electronic game has taken an action that corresponds to the preference to play the secondary game, presenting and executing the secondary game.

13. The system of claim 12, wherein the instructions:
determine, by the machine learning network, that the player has taken the action that corresponds to the preference to play the secondary game, further comprise instructions to cause the processor to determine, by the machine learning network, that the player has the preference to play one of a plurality of secondary games comprising the secondary game and, in response, enabling play of a preferred secondary game of the plurality of secondary games; and
determine, by the processor, that the electronic game has triggered play of the preferred secondary game and the preferred secondary game has been enabled, further comprise instructions to cause the processor to present the preferred secondary game.

14. The system of claim 13, wherein the machine learning network is trained with a combination gameplay behavior of the one or more players in the prior gaming sessions, secondary game attributes of each of the plurality of secondary games, and preferences of the one or more players in the prior gaming sessions for each of the plurality of secondary games.

15. The system of claim 12, wherein:
the instructions to generate a prompt comprising the gameplay of the player in the electronic game to the gameplay behavior of the one or more players in prior gaming sessions to determine a set of secondary game preferences of the player, further comprise instructions to correlating gameplay of the player in the electronic game to gameplay behavior of the one or more players in the prior gaming sessions to determine the set of secondary game preferences of the player, player attributes for the one or more players in the prior gaming sessions, secondary game attributes of each of a plurality of secondary games comprising at least the secondary game, and preferences of the one or more players in the prior gaming sessions for each of the plurality of secondary games; and
the instructions further cause the processor to provide the prompt to the machine learning network to determine, by the machine learning network, that the player has the preference to play one of the plurality of secondary games, and in response, executing and presenting the one of the plurality of secondary games.

16. The system of claim 12, wherein:
the instructions further cause the processor to determine, by the machine learning network, a degree of preference of the player to play each of a plurality of secondary games comprising at least the secondary game;
the instructions further cause the processor to determine a weight for each of the plurality of secondary games in accordance with the degree of preference; and
the instructions further cause the processor to determine that the electronic game has triggered the secondary game and the secondary game is enabled and in response, present, by the processor, a weighted randomized secondary game from the plurality of secondary games.

17. The system of claim 16, wherein:
the instructions further cause the processor to, upon presentation of the weighted randomized secondary game, generate, at least one of a decrement to the weight of the weighted randomized secondary game or an increment to at least one of the plurality of secondary games that exclude the weighted randomized secondary game; and
the instructions further cause the processor to modify the weight of at least one of the weight of the weighted randomized secondary game or the weight of at least one of the plurality of secondary games that exclude the weighted randomized secondary game.

18. A system, comprising:
a processor; and
a memory coupled with and readable by the processor and having stored thereon instructions which, when executed by the processor, cause the processor to:
generate, by a machine learning model, a representative player of an electronic game comprising a plurality of representative player attributes and a preference for a bonus game of a plurality of bonus games;
execute the electronic game, wherein the electronic game presents a plurality of game features to a player during execution thereof;
determine a variation of player attributes of the player from the plurality of representative player attributes and modify the bonus game in accordance with the variation; and
determine, by the processor, that the electronic game has triggered play of the bonus game and in response executing and presenting, by the processor, the bonus game.

19. The system of claim 18, wherein the machine learning model comprises a trained machine learning model trained with a combination of demographic attributes of one or more players in prior gaming sessions, game play behavior attributes of the one or more players in the prior gaming sessions, game play behavior attributes of the one or more players in the prior gaming sessions when presented with of one of the plurality of bonus games, and game play behavior attributes of the one or more players in the prior gaming sessions after being presented with of one of the plurality of bonus games.

20. The system of claim 18, wherein the representative player comprises an aggregation of a plurality of one or more players in prior gaming sessions having at least one attribute of the one or more players in prior gaming sessions in common with at least one player attribute.
